(19) United States
(12) Patent Application Publication
(10) Pub. No.: US 2012/0250713 A1
(43) Pub. Date: Oct. 4, 2012

(54) CORRECTION CIRCUIT, DRIVING CIRCUIT, LIGHT EMITTING APPARATUS, AND METHOD OF CORRECTING ELECTRIC CURRENT PULSE WAVEFORM

(75) Inventors: Osamu Maeda, Miyagi (JP); Katsuhisa Daio, Kagoshima (JP); Shoji Honda, Miyagi (JP)

(73) Assignee: SONY CORPORATION, Tokyo (JP)

(21) Appl. No.: 13/414,831

(22) Filed: Mar. 8, 2012

(30) Foreign Application Priority Data
Mar. 30, 2011 (JP) 2011-075468

(51) Int. Cl. H01S 3/02

(52) U.S. Cl. 372/38.02

(57) ABSTRACT

A correction circuit includes: a temperature rise derivation section which derives a temperature rise amount of a first channel of a multi-channel surface-emitting laser array due to the heating by at least one or a plurality of second channels adjacent to the first channel out of all channels included in the laser array; and a first correction section which corrects a waveform of an electric current pulse which is output from an electric current source capable of independently driving the laser array for each channel, to the first channel, based on the temperature rise amount derived by the temperature rise derivation section.

### FIELD

The present disclosure relates to a correction circuit that corrects an electric current pulse waveform which is applied to a semiconductor laser array including a vertical resonator structure, and a driving circuit and a light emitting apparatus including the same. Furthermore, the present disclosure relates to a method of correcting the electric current pulse waveform which is applied to the semiconductor laser.

### BACKGROUND

Unlike a Fabry-Perot resonator type semiconductor laser of the related art, a surface-emitting semiconductor laser emits light in a direction perpendicular to a substrate, and is able to arrange a plurality of resonator structures in the form of a two-dimensional array on the same substrate. For this reason, recently, the surface-emitting semiconductor laser has garnered attention in technical fields such as a data communication and a printer.

The surface-emitting semiconductor laser generally includes a columnar vertical resonator structure which is formed by stacking a lower DBR layer, a lower spacer layer, an active layer, an upper spacer layer, an electric current confinement layer, an upper DBR layer, and a contact layer on a substrate in this order. In such a semiconductor laser, it is known that the optical output is significantly changed by a change in an active layer temperature. For example, when the surface-emitting semiconductor laser having an oscillation wavelength of 650 nm is driven at 1 mW, the active layer temperature is merely changed from 50° C. to 60° C., whereby the optical output falls by about 20%.

Furthermore, in this surface-emitting semiconductor laser, the vertical resonator is extremely small, and the active layer temperature easily rises by an electric current injection. For that reason, in a laser array with a plurality of integrated surface-emitting semiconductor lasers, when all semiconductor lasers are driven and the active layer temperature of each semiconductor laser rises, the active layer temperature of the individual semiconductor laser further rises due to heat transmitted from the adjacent another semiconductor lasers. As a consequence, the optical output of the individual semiconductor laser falls. For example, in the surface-emitting laser array of 45 μm pitch and 4×8 channel, when driving the respective semiconductor lasers at 50° C. and 1 mW, the active layer temperatures of each semiconductor laser become higher by 10° C. or more than the active layer temperature when causing a single channel to emit light. Thus, the optical output of the individual semiconductor laser falls by about 20%. In this manner, in the surface-emitting laser array, there is a problem in that thermal crosstalk is generated in which the optical output falls by heat generated by the other adjacent semiconductor laser.

Various methods of coping with the thermal crosstalk are suggested, and, for example, JP-A-2000-190563 discloses a method of coping with a crosstalk in Fabry-Perot type semiconductor laser. JP-A-2000-190563 discloses a technique which determines a suitable correction electric current amount by calculating a temperature rise of the device generated by the driving of a laser, and suppresses a decline in optical output due to the thermal crosstalk by driving the laser using the corrected electric current.

### SUMMARY

In the method described in JP-A-2000-190563, the correction electric current amount is a value that is equal to a threshold value rise due to the temperature rise of the laser device. However, in the actual semiconductor laser, since slope efficiency is changed by the temperature rise and the injected electric current, the electric current amount to be corrected will be equal to or greater than a change in a threshold value. Particularly, in the surface-emitting semiconductor laser, a change in a threshold value due to the temperature change is small, and on the contrary, a change in slope efficiency is great. Thus, it is necessary to determine the correction electric current amount in view of considering the variation of the slope efficiency. That is, in the method disclosed in JP-A-2000-190563, it is difficult to improve the thermal crosstalk in the surface-emitting laser array.

It is therefore desirable to provide a correction circuit that is able to alleviate the influence of the thermal crosstalk in the surface-emitting laser array, a driving circuit and a light emitting apparatus including the same. Furthermore, it is desirable to provide a method of correcting an electric current pulse waveform that is able to improve the thermal crosstalk in the surface-emitting laser array.

An embodiment of the present disclosure is directed to a correction circuit including a temperature rise derivation section and a first correction section. The temperature rise derivation section derives a temperature rise amount of a first channel of a multi-channel surface-emitting laser array due to the heating by at least one or a plurality of second channels adjacent to the first channel out of all channels included in the laser array. The first correction section corrects a waveform of an electric current pulse which is output from an electric current source, capable of independently driving the laser array for each channel, to the first channel, based on the temperature rise amount derived by the temperature rise derivation section.

Another embodiment of the present disclosure is directed to a driving circuit including an electric current source that is able to independently drive a multi-channel surface-emitting laser array for each channel, and a correction circuit that corrects the waveform of the electric current pulse output from the electric current source. The correction circuit included in the driving circuit has the same components as that of the correction circuit.

Still another embodiment of the present disclosure is directed to a light emitting apparatus including a multi-channel surface-emitting laser array, and a driving circuit that drives the laser array. The driving circuit included in the light emitting apparatus has the same components as that of the above driving circuit.

Yet another embodiment of the present disclosure is directed to a method of correcting an electric current pulse waveform including the following two steps: (A) deriving a temperature rise amount of a first channel of a multi-channel surface-emitting laser array due to the heating by at least one or a plurality of second channels adjacent to the first channel out of all channels included in the laser array, and (B) correcting a waveform of an electric current pulse output from an electric current source, which is able to independently drive the laser array for each channel, to the first channel, based on the temperature rise amount derived in the temperature rise derivation.

In the correction circuit, the driving circuit, the light emitting apparatus, and the method of correcting an electric current pulse waveform according to the embodiments of the present disclosure, the waveform of the electric pulse output from the electric current source to the first channel is corrected based on the temperature rise amount of the first channel due to the heating by the second channel around the first channel. As a result, it is possible to bring the optical output of the laser array closer to the optical output of when not affected by the thermal crosstalk.

According to the correction circuit, the driving circuit, the light emitting apparatus, and the method of correcting an electric current pulse waveform according to the embodiments of the present disclosure, since the optical output of the laser array can be brought closer to the optical output of when not affected by the thermal crosstalk, it is possible to alleviate the influence of the thermal crosstalk in the surface-emitting laser array.

### BRIEF DESCRIPTION OF THE DRAWINGS

FIG. 1 is a diagram that shows an example of an upper surface configuration of a semiconductor laser array according to an embodiment of the present disclosure;

FIG. 2 is a diagram that shows an example of a schematic configuration of a light emitting apparatus including the semiconductor laser array of FIG. 1;

FIG. 3 is a diagram that shows an example of an internal configuration of a laser driving section of FIG. 2;

FIGS. 4A and 4B are diagrams that show an example of electric current-optical output characteristics and electric current-slope efficiency characteristics of the laser device of FIG. 1;

FIG. 5 is a schematic diagram for describing a transmission of heat generated by the semiconductor laser array of FIG. 1;

FIGS. 6A to 6C are diagrams that show an example of a waveform of electric current which is applied to ch2 to ch4 of FIG. 5;

FIG. 7 is a diagram that shows an example of a heat flow, a thermal resistance, and a thermal time constant for each ch2 to ch4 of FIG. 5;

FIGS. 8A to 8D are diagrams that show an example of ΔT₂→₁(t), ΔT₃→₁(t), ΔT₄→₁(t), and ΣₓΔTₓ→₁(t)

FIG. 9 is a diagram that shows an example of ΔIch1(t) when ΔT₂→₁(t), ΔT₃→₁(t), ΔT₄→₁(t), and ΣₓΔTₓ→₁(t) are equal to those of FIGS. 8A to 8D;

FIG. 10 is a diagram that shows an example of an internal configuration of the correction circuit of FIG. 3;

FIG. 11 is a diagram that shows a first modified example of the laser driving section of FIG. 3;

FIGS. 12A to 12C are diagrams that show an example of en electric current pulse waveform generated in the laser driving section of FIG. 11;

FIG. 13 is a diagram that shows an example of I-L characteristics of the laser device of FIG. 1;

FIGS. 14A and 14B are diagrams that show an example of an optical output waveform of the laser device of FIG. 1;

FIGS. 15A to 15E are waveform diagrams for describing a synthesis of a waveform of Iₒₚ₁(t) of FIG. 11 and a waveform of I_{A1}(t) of FIG. 11;

FIG. 16 is a diagram that shows a schematic configuration of the laser device of FIG. 1 and an example of a thermal circuit;

FIG. 17 is a waveform diagram for describing variables included in a heat equation;

FIG. 18A is a diagram that shows a time change of an active layer temperature obtained by solving the heat equation;

FIG. 18B is a diagram that shows a relationship between the active layer temperature obtained by an actual measurement and an optical output;

FIG. 18C is a diagram that shows a time change of the optical output obtained from FIGS. 8A and 8B;

FIG. 19 is a diagram that shows an actually measured value and a calculated value of the time change of the optical output;

FIG. 20 is a diagram that shows a second modified example of the laser driving section of FIG. 3;

FIG. 21 is a diagram that shows an example of an injected electric power dependency of droop;

FIGS. 22A to 22C are diagrams that show an example of the electric current pulse waveform generated in the laser driving section of FIG. 20;

FIGS. 23A to 23C are diagrams that show an example of the optical output waveform of the laser device of FIG. 1;

FIGS. 24A to 24E are waveform diagrams for describing a synthesis of the waveform of Iₒₚ₁(t) of FIG. 20 and the waveform of I_{B1}(t) of FIG. 20;

FIG. 25 is a diagram that shows a third modified example of the laser driving section of FIG. 1;

FIGS. 26A to 26C are diagrams showing an example of the electric current pulse waveform generated in the laser driving section of FIG. 25;

FIG. 27 is a schematic configuration diagram of a printing apparatus according to a first application example; and

FIG. 28 is a schematic configuration diagram of an optical communication apparatus according to another application example.

### DETAILED DESCRIPTION

Hereinafter, an embodiment of the present disclosure will be described in detail with reference to the drawings. In addition, the description will be provided in the following order.

### 1. Embodiment

Example Provided With Circuit for Alleviating Influence of Thermal Crosstalk

### 2. Modified Example

Example Provided With Circuit for Reducing Waveform Dullness of Optical Output due to Wavelength Detuning Example Provided With Circuit for Reducing Decline in Optical Output due to Droop

### 3. Application Example

Example in Which Light Emitting Apparatuses of Each Embodiment Are Used as Light Source of Printing Apparatus
Example in Which Light Emitting Apparatuses of Each Embodiment Are Used as Light Source of Optical Communication Apparatus

### 1. Embodiment

### Configuration of Semiconductor Laser Array 1

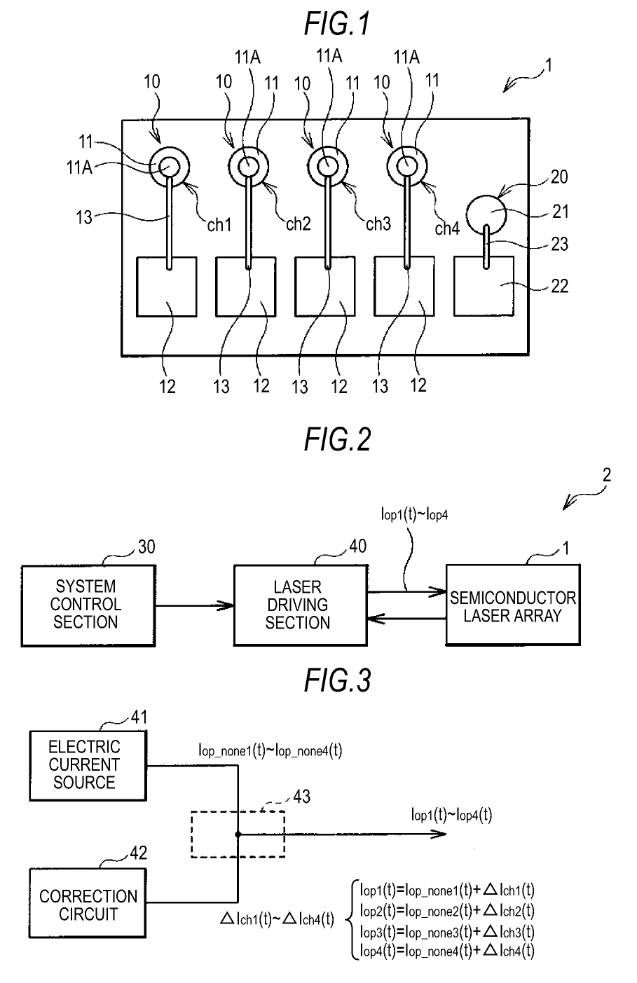

FIG. 1 shows a top view of a semiconductor laser array 1 according to an embodiment. In addition, FIG. 1 is schematically shown and is different from actual size and shape. The semiconductor laser array 1 is configured by integrating a plurality of surface-emitting laser devices 10. In the semiconductor laser array 1, an individual laser device 10 is called a channel. As shown in FIG. 1, when four laser devices 10 are provided, the semiconductor laser array 1 is called a four channel laser array.

The respective laser devices 10 are placed on the upper surface such that distances between optical axes of laser beams emitted from the respective laser devices 10 become closer to each other as much as possible. For example, as shown in FIG. 1, the respective laser devices 10 are arranged in a horizontal row. In addition, although not shown, the respective laser devices 10 may be placed in a grid shape. Furthermore, FIG. 1 shows a case where four laser devices 10 are placed, but only two laser devices 10 may be placed, three laser devices 10 may be placed, and five or more laser devices 10 may be placed. In addition, hereinafter, the semiconductor laser array 1 will be described of a case where four laser devices 10 are placed.

The respective laser devices 10 are, for example, formed on a common substrate (not shown) through crystal growth. In addition, the respective laser devices 10 may be placed on a common substrate (not shown) by bonding.

For example, the laser device 10 has a columnar vertical resonator structure with an active layer interposed between a pair of multilayer film reflecting mirrors. The active layer includes, for example, red-based materials (for example, GaInP or AlGaInP). In addition, the active layer may be formed of other materials, and may include, for example, infrared-based materials (for example, GaAs or AlGaAs). For example, the laser device 10 has an annular upper electrode 11 having an opening 11A on an upper surface of the vertical resonator structure, and emits a laser beam from the opening 11A. The laser device 10 further has an electrode pad 12 adjacent to the vertical resonator structure, and has a connection section 13 that electrically connects the upper electrode 11 with the electrode pad 12 each other.

The semiconductor laser array 1 has a temperature detection device 20 in addition to the laser device 10. The temperature detection device 20 is, for example, provided on a substrate (not shown) common to the laser device 10, and is formed, for example, on the substrate common to the laser device 10 by the crystal growth. In addition, the temperature detection device 20 may be placed on the substrate common to the laser device 10 by the bonding.

Like the laser device 10, for example, the temperature detection device 20 has a columnar resonator structure with an active layer interposed between a pair of multilayer film reflecting mirrors. The active layer of the temperature detection device 20 is formed of, for example, the same material as the active layer of the laser device 10, and, for example, includes red-based materials (for example, GaInP or AlGaInP). In addition, the active layer of the temperature detection device 20 may be formed of other materials. For example, the active layer may include infrared-based materials (for example, GaAs or AlGaAs).

For example, the temperature detection device 20 has a plate-like upper electrode 21 not having an opening on the upper surface of the vertical resonator structure, so that laser beam is not emitted from the upper surface of the vertical resonator structure. The temperature detection device 20 further has an electrode pad 22 adjacent to the vertical resonator structure, and a connection section 23 that electrically connects the upper electrode 21 with the electrode pad 22 each other. The temperature detection device 20 detects the ambient temperature through the use of a change in series resistance of the temperature detection device 20 generated by a change in active layer temperature due to a change of the ambient temperature when normal electric current flows in the temperature detection device 20. Specifically, the temperature detection device 20 is adapted to output a change in series resistance of the temperature detection device 20 to the electrode pad 22 as a change in voltage of the upper electrode 21.

### Configuration of Light Emitting Apparatus 2

FIG. 2 shows a schematic configuration of the light emitting apparatus 2 including the semiconductor laser array 1. The light emitting apparatus 2 includes the semiconductor laser array 1, a system control section 30, and a laser driving section 40. The system control section 30 controls the driving of the semiconductor laser array 1 via the laser driving section 40.

The laser driving section 40 injects the electric current to the semiconductor laser array 1, thereby causing the semiconductor laser array 1 to emit light. For example, as shown in FIG. 3, the laser driving section 40 has an electric current source 41, a correction circuit 42, and a synthesis section 43.

The electric current source 41 is able to independently drive the multi-channel semiconductor laser array 1 for each channel, and is able to output four types of electric currents (I_{op none1}(t) to I_{op none4}(t)), as shown in FIG. 3. The electric current source 41 pulse-drives the semiconductor laser array 1, and is, for example, adapted to output a rectangular electric current pulse as four types of electric currents (I_{op none1}(t) to I_{op none4}(t)). Meanwhile, the correction circuit 42 corrects the waveform of the electric current pulse output from the electric current source 41, and, for example, is able to output the four types of correction electric currents (ΔI_{ch1}(t) to ΔI_{ch4}(t)), as shown in FIG. 3.

The synthesis section 43 is adapted to synthesize the electric current output from the electric current source 41 with the correction electric current output from the correction circuit 42, and output the synthesized electric current to the outside (specifically, the semiconductor laser array 1). For example, as shown in FIG. 3, the synthesis section 43 has a connection section which connects an output end of the electric current source 41 with an output end of the correction circuit 42, and is able to add (superimpose) the electric current output from the electric current source 41 to the correction electric current output from the correction circuit 42. For example, the synthesis section 43 is able to output four types of electric currents (Iₒₚ₁(t) to Iₒₚ₄(t)) in which the electric currents (I_{op none1}(t) to I_{op none4}(t)) output from the electric current source 41 are added to the correction electric currents (ΔI_{ch1}(t) to ΔI_{ch4}(t)) output from the correction circuit 42.

Next, a derivation course of the correction electric current generated in the correction circuit 42 will be described.

### (Modeling of Temperature Characteristics of Single Device)

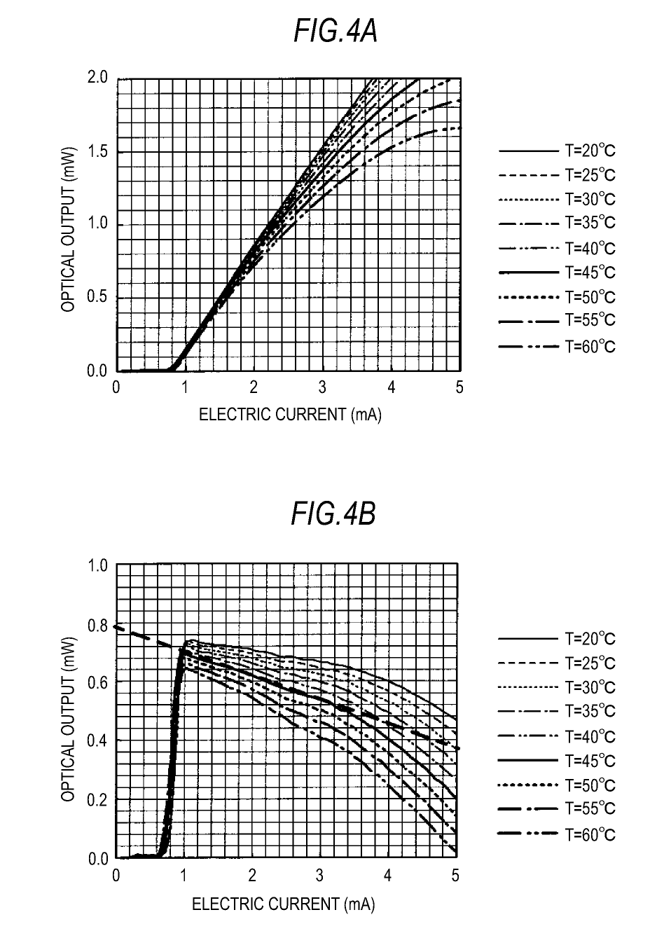

FIG. 4A shows an example of a temperature dependency of electric current optical output characteristics of a surface-emitting red semiconductor laser. FIG. 4B shows an example of a temperature dependency of electric current slope efficiency characteristics of the surface-emitting red semiconductor laser. In addition, FIG. 4B is obtained by differentiating the electric current optical output characteristics of FIG. 4A by the electric current. It is understood from FIG. 4B that, when the magnitude of the electric current is about 3 mA from a threshold value, the slope efficiency is linearly reduced with respect to the electric current, the temperature thereof rises, and the gradient (slope) of the slope efficiency becomes smaller. The variation in slope efficiency due to the temperature and electric current changes can be expressed by the following model equation.

SE(I,T)=(−a·T+b)(I−Ic)+ηC [Equation 1]

Herein, the symbol T is an ambient temperature. The symbol I is an electric current (a driving electric current) that is input to the semiconductor laser. The symbol SE (I, T) is slope efficiency and includes the ambient temperature T and the driving electric current I as variables. Symbols a, b, I_{c}, and η_{C} are constants that are different depending on the characteristics of the semiconductor laser. For example, in the case of red semiconductor laser shown in FIGS. 4A and 4B, the symbols a, b, I_{c}, and η_{C} adopt values described as below.

$$\{ \begin{matrix}\begin{matrix}\begin{matrix}a = 0.002224 [ \frac{mW}{{( mA )}^{2} ° C .} ] \\ b = 0.0099334 [ \frac{mW}{{( mA )}^{2}} ]\end{matrix} \\ {I}_{c} = - 0.2 [ mA ]\end{matrix} \\ {η}_{c} = 0.79 [ \frac{mW}{mA} ]\end{matrix} \qquad [ Equation 2 ]$$

Upon integrating the equation 1, the electric current optical output characteristic described below is obtained. In addition, in the equation 1, the symbol P (I, T) is an optical output, and includes the ambient temperature T and the driving electric current I as variables. The symbol const is a constant.

$$P ( I , T ) = \frac{1}{2} ( - aT + b ) {( I - {I}_{c} )}^{2} + {η}_{c} \cdot I + const . \qquad [ Equation 3 ]$$

(Electric Current that Corrects Optical Output Decline Due to Temperature Rise)

The electric current, which corrects the optical output variation (ΔP) due to a change in the ambient temperature T, is can be derived as below. If there is no optical output fluctuation by the temperature change and the electric current change, the following equation is obtained from the equation 3.

$$Δ P = P ( I + Δ I , T + Δ T ) - P ( I , T ) = \frac{\partial P}{\partial I} Δ I + \frac{\partial P}{\partial T} Δ T = 0 \qquad [ Equation 4 ]$$

In addition, the symbol ΔT is a change amount of the ambient temperature T. The symbol ΔI is a change amount of the driving electric current I. By substituting the equation 3 to the equation 4, the following equations are obtained.

$$\begin{matrix}( - aT + b ) ( I - {I}_{c} ) Δ I - \frac{1}{2} {a ( I - {I}_{c} )}^{2} + {η}_{c} Δ I = 0 & [ Equation 5 ] \\ Δ I = \frac{( a / 2 ) {( I - {I}_{c} )}^{2}}{( - aT + b ) ( I - {I}_{c} ) + {η}_{c}} \cdot Δ T & [ Equation 6 ]\end{matrix}$$

It is understood from the equation 6 that the electric current value to be corrected becomes greater by an increase in driving electric current I and an increase in ambient temperature T.

(Temperature Rise of Channel of Interest due to Driving Other than Channel of Interest)

FIG. 5 schematically shows the transmission of heat generated in the semiconductor laser array 1. As shown in FIG. 5, when the temperature rise amount received by the laser device 10 of the channel ch1 through the heating of the laser devices 10 of the channels ch2, ch3, and ch4 around the channel ch1 is expressed by ΔTₓ→₁ (x is 2, 3, and 4), a differential equation concerning the time of the temperature rise amount ΔTₓ→₁ can be expressed as below.

$$\{ \begin{matrix}Δ {T}_{x \to 1} - {W}_{x} {R}_{x \to 1} + {R}_{x \to 1} {C}_{x \to 1} \frac{d ( Δ {T}_{x \to 1} )}{d t} = 0 & ON \\ Δ {T}_{x \to 1} + {R}_{x \to 1} {C}_{x \to 1} \frac{d ( Δ {T}_{x \to 1} )}{d t} = 0 & OFF\end{matrix} \} \qquad [ Equation 7 ]$$

Herein, Wₓ→₁ is a heat flow that is generated by the light emission of the channel chₓ (x is 2, 3, and 4). Rₓ→₁ is a thermal resistance between the channel chx and channel ch1. Cₓ→₁ is a heat capacity between the channel chx and channel ch1. By solving the differential equation, it is possible to derive the temperature rise amount ΔTₓ→₁ of the channel ch1 due to the heating of the channel chx.

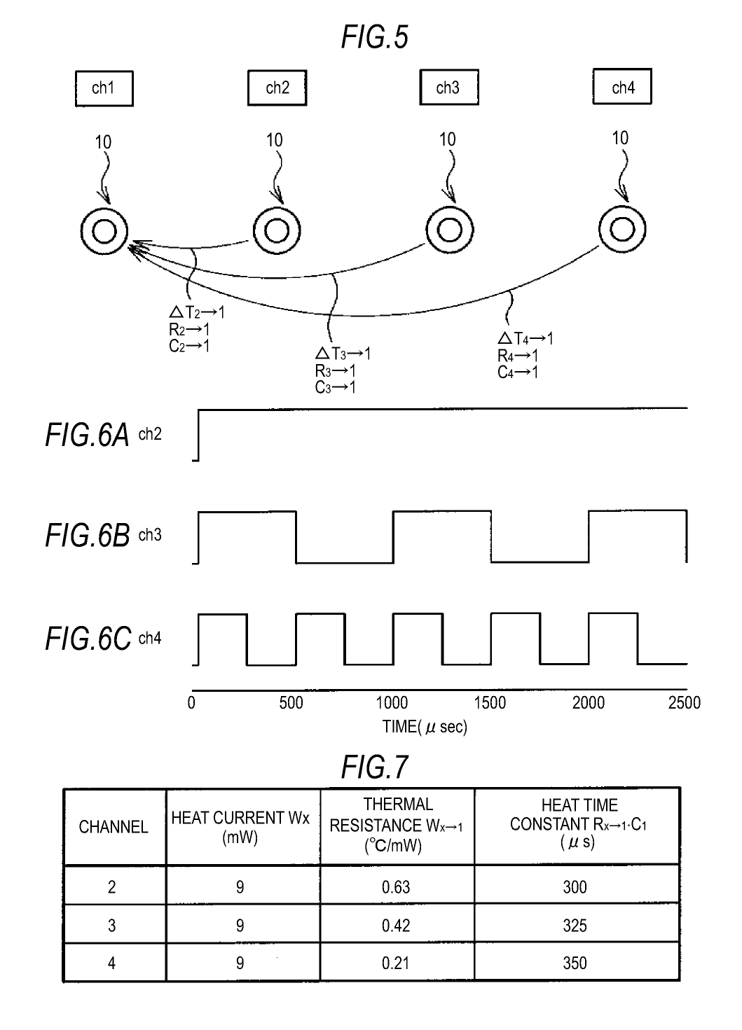

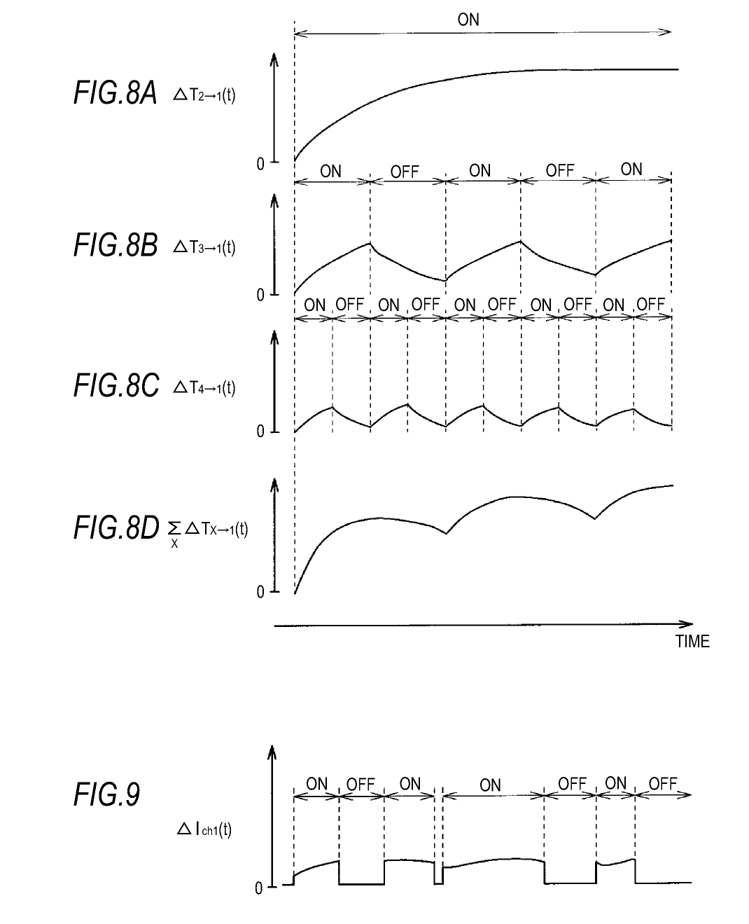

Next, in order to estimate the temperature rise amount of the channel ch1 with the total contribution of the heating of all channels chx, for example, a data pattern like FIGS. 6A to 6C is assumed. The thermal resistance, the heat time constant, and the heat flow of each channel x are set like FIG. 7. Upon substituting them into the differential equation (equation 7) and solving the same to ΔTₓ→₁(t), the temperature of the channel ch1 indicates the change like FIGS. 8A to 8D.

$${\sum }_{x} Δ {T}_{x \to 1} ( t ) \qquad [ Equation 8 ]$$

### (Correction Electric Current Amount Derivation)

By substituting the equation 8 mentioned above into the equation 6, the following is obtained.

$$Δ I = \frac{( a / 2 ) {( I - {I}_{c} )}^{2}}{( - aT + b ) ( I - {I}_{c} ) + {η}_{c}} \cdot {\sum }_{x} Δ {T}_{x \to 1} ( t ) \qquad [ Equation 9 ]$$

Moreover, the correction electric current can be derived by solving the equation 9 mentioned above. The symbol T is an ambient temperature, but is detected as the voltage when causing a constant electric current to flow in the temperature detection device 20. The voltage is data-held before driving the semiconductor laser array 1 and is a constant value while driving the semiconductor laser array 1. Upon actual calculation, a result as in FIG. 9 is obtained. Herein, the numerical values described in the equation 2 are used in various parameters. Furthermore, the ambient temperature T was set to 50° C., and the driving electric current I was set to 3 mA.

### (Circuit Configuration)

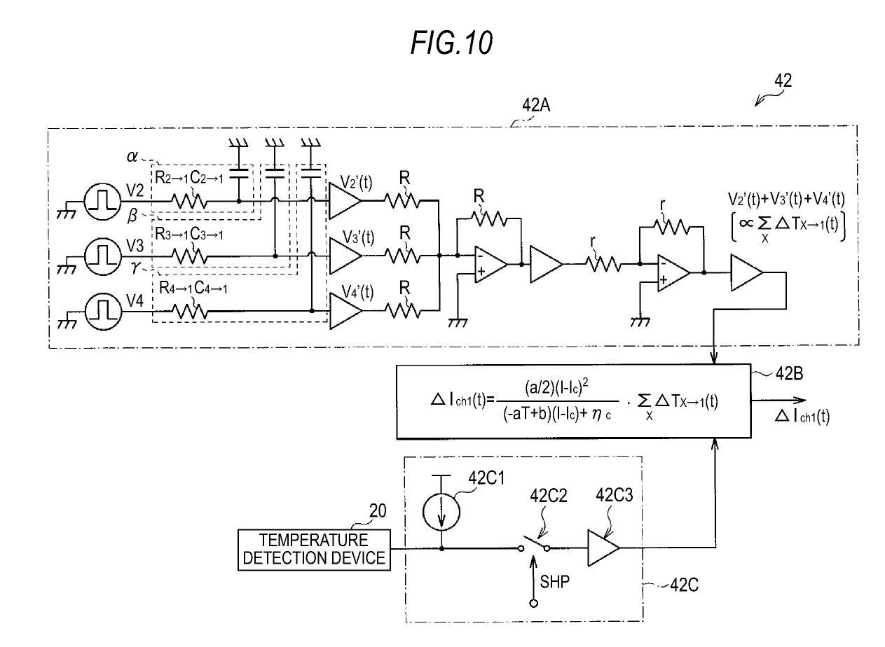

Next, an internal configuration of the correction circuit 42 will be described. FIG. 10 shows an example of an internal configuration of the correction circuit 42. For example, as shown in FIG. 10, the correction circuit 42 has a temperature rise derivation section 42A, a correction section 42B, and an ambient temperature derivation section 42C.

The temperature rise derivations section 42A derives the temperature rise amount of a device of interest due to the heating by at least one or plurality of laser devices 10 (hereinafter, conveniently, referred to as a “periphery channel”) adjacent to a channel (hereinafter, conveniently referred to as a “channel of interest”) of all channels included in the semiconductor laser array 1.

For example, as shown in FIG. 10, the increase temperature rise derivation section 42A is adapted to derive the temperature rise amount ΣₓΔTₓ→₁(t) of the channel ch1 with the total contribution of the heating of all channels ch2, ch3, and ch4.

For example, the temperature rise derivation section 42A has a circuit a of an RC time constant (R₂→₁×C₂→₁) which includes a heat resistance R₂→₁ and a thermal capacity C₂→₁ corresponding to a pass (a heat passage) between the channel ch2 and the channel ch1. The temperature rise derivation section 42A has a voltage source V2 which is connected to an input end of the circuit α. The voltage source V2 corresponds to a product (W₂→₁×R₂→₁) of the heat resistance R₂→₁ and the heat flow W₂→₁ corresponding to the pass between the channel ch2 and the channel ch1. Thus, the temperature rise amount ΔT₂→₁(t) of the channel ch1 due to the driving of the channel ch2 is represented by a voltage V2′(t) which is changed according to the RC time constant (R₂→₁×C₂→₁).

Similarly, for example, the temperature rise derivation section 42A has a circuit β of an RC time constant (R₃→₁×C₃→₁) which includes a heat resistance R₃→₁ and a thermal capacity C₃→₁ corresponding to a pass (a heat passage) between the channel ch3 and the channel ch1. The temperature rise derivation section 42A has a voltage source V3 which is connected to an input end of the circuit β. The voltage source V3 corresponds to a product (W₃→₁×R₃→₁) of the heat resistance R₃→₁ and the heat flow W₃→₁ corresponding to the pass between the channel ch3 and the channel ch1. Thus, the temperature rise amount ΔT₃→₁(t) of the channel ch1 due to the driving of the channel ch3 is represented by a voltage V3′(t) which is changed according to the RC time constant (R₃→₁×C₃→₁).

In addition, for example, the temperature rise derivation section 42A has a circuit γ of an RC time constant (R₄→₁×C₄→₁) which includes a heat resistance R₄→₁ and a thermal capacity C₄→₁ corresponding to a pass (a heat passage) between the channel ch4 and the channel ch1. The temperature rise derivation section 42A has a voltage source V4 which is connected to an input end of the circuit γ. The voltage source V4 corresponds to a product (W₄→₁×R₄→₁) of the heat resistance R₄→₁ and the heat flow W₄→₁ corresponding to the pass between the channel ch4 and the channel ch1. Thus, the temperature rise amount ΔT₄→₁(t) of the channel ch1 due to the driving of the channel ch4 is expressed by a voltage V4′(t) which is changed according to the RC time constant (R₄→₁×C₄→₁).

For example, the temperature rise derivation section 42A derives the total of the temperature rise amount ΔT₂→₁(t), the temperature rise amount ΔT₃→₁(t), and the temperature rise amount ΔT₄→₁(t) by the respective channels ch2, ch3, and ch4, by synthesizing the voltages V2′(t), V3′(t), and V4′(t) by an addition circuit and an inverting amplification circuit. In this manner, the temperature rise derivation section 42A is adapted to derive the temperature rise amount ΣxΔTₓ→₁(t) of the channel ch1 with the total contribution of the heating of all channels ch2, ch3, and ch4.

Similarly, the temperature rise derivation section 42A is adapted to derive the temperature rise amount ΣₓΔTₓ→₂(t) of the channel ch2 with the total contribution of the heating of all channels ch1, ch3, and ch4. In addition, the temperature rise derivation section 42A is adapted to derive the temperature rise amount ΣₓΔTₓ→₃(t) of the channel ch3 with the total contribution of the heating of all channels ch1, ch2, and ch4. Additionally, the temperature rise derivation section 42A is adapted to derive the temperature rise amount ΣₓΔTₓ→₄(t) of the channel ch4 with the total contribution of the heating of all channels ch1, ch2, and ch3.

For example, the ambient temperature detection section 42C includes an electric current source 42C1 which causes a constant electric current through the temperature detection device 20, a switch 42C2 which samples the voltage obtained from the temperature detection device 20, and a buffer circuit 42C3 which outputs the sampled voltage to the correction section 42B. The switch 42C2 is subjected to on-off control, for example, by a SHP (a sample hold pulse). The ambient temperature derivation section 42C is adapted to hold the voltage equivalent to the ambient temperature T by turning the switch 42C2 from on to off.

For example, the correction section 42B includes a multiplier and a divider and is adapted to generate the correction electric current by calculating the equation 9 mentioned above through the use of the multiplier and the divider. The correction section 42B is adapted to generate the correction electric current, based on the temperature rise amount derived by the temperature rise derivation section 42A, the ambient temperature, and the electric current amount which is output to the channel of interest.

For example, the correction section 42B is adapted to generate a correction electric current ΔI_{ch1}(t) based on the temperature rise amount ΣₓΔTₓ→₁(t) derived by the temperature rise derivation section 42A, the ambient temperature T, and an electric current I_{op none1}(t) which is output for the channel ch1. Similarly, for example, the correction section 42B is adapted to generate a correction electric current ΔI_{ch2}(t) based on the temperature rise amount ΣₓΔTₓ→₂(t) derived by the temperature rise derivation section 42A, the ambient temperature T, and an electric current I_{op none2}(t) which is output for the channel ch2. Furthermore, for example, the correction section 42B is adapted to generate a correction electric current ΔI_{ch3}(t) based on the temperature rise amount ΣₓΔTₓ→₃(t) derived by the temperature rise derivation section 42A, the ambient temperature T, and an electric current I_{op none3}(t) which is output for the channel ch3. Furthermore, for example, the correction section 42B is adapted to generate a correction electric current ΔI_{ch4}(t) based on the temperature rise amount ΣₓΔTₓ→₄(t) derived by the temperature rise derivation section 42A, the ambient temperature T, and an electric current I_{op none4}(t) which is output for the channel ch4.

In addition, the ambient temperature is preferably a value which is input from the ambient temperature derivation section 42C, but, in some cases, the ambient temperature may be a constant. Furthermore, the electric current amount output to the channel of interest is preferably a value which is input from the system control section 30, but, in some cases, the electric current amount may be a constant.

### [Operation]

Next, an operation of the light emitting apparatus 1 of the present embodiment will be described. In the present embodiment, rectangular electric current pulses (I_{op none1}(t) to I_{op none4}(t)) are output from the electric current source 41. At this time, the correction electric currents (ΔI_{ch1}(t) to ΔI_{ch4}(t)) correcting the rectangular electric current pulse are output from the electric current source 41, from the correction circuit 42. After that, electric current pulses (Iₒₚ₁(t) to Iₒₚ₄(t)), in which the electric current pulses (I_{op none1}(t) to I_{op none4}(t)) and the correction electric currents (ΔI_{ch1}(t) to ΔI_{ch4}(t)) are superimposed on each other, are applied to the semiconductor laser array 1 by the laser driving section 40. As a result, an optical output of a desired magnitude is emitted from the semiconductor laser array 1 to the outside.

### [Effect]

In the present embodiment the waveform of the electric current pulse output from the electric current source 41 to the channel of interest is corrected, based on the temperature rise amount ΣₓΔTₓ→₁(t) of the channel of interest due to the heating in the periphery channel around the channel of interest. As a result, the optical output of the semiconductor laser array 1 can be brought closer to the optical output of when not affected by the thermal crosstalk. As a consequence, it is possible to alleviate the influence of the thermal crosstalk in the semiconductor laser array 1.

Furthermore, in the present embodiment, the correction section 42B corrects the temperature rise amount ΣₓΔTₓ→₁(t) based on the ambient temperature T becoming the variation factors of the optical output and the electric current amount output to the channel of interest. As a consequence, it is possible to further alleviate the influence of the thermal crosstalk in the semiconductor laser array 1.

### 2. Modified Example

### First Modified Example

In the present modified example, the active layer includes, for example, red-based materials (for example, GaInP or AlGaInP). At this time, a wavelength detuning Δλ, which is the difference between the light emitting wavelength of the active layer of each laser device 10 and the oscillation wavelength of each laser device 10, is equal to or greater than 15 nm. In addition, the active layer may be formed of other materials, and, for example, may be formed of infrared-based materials (for example, GaAs or AlGaAs). At this time, the wavelength detuning Δλ is equal to or greater than 13 nm.

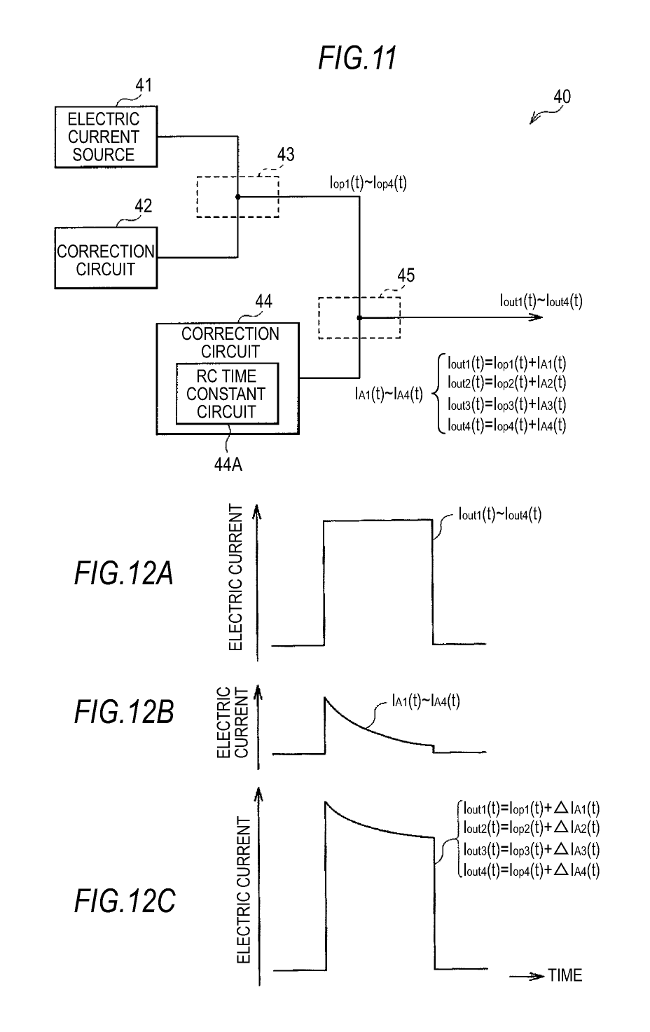

FIG. 11 shows an example of a schematic configuration of the laser driving section 40 according to the present modified example. The laser driving section 40 according to the present modified example has an electric current source 41, a correction circuit 42, a synthesis section 43, a correction circuit 44, and a synthesis section 45.

The correction circuit 44 has an RC time constant circuit 44A, and is adapted to correct the waveforms of the electric current pulses (Iₒₚ₁(t) to Iₒₚ₄(t)) output from the synthesis section 43 through the use of the RC time constant circuit 44A such that the pulse waveform of the optical output of the semiconductor laser array 1 becomes closer to a rectangular shape.

The RC time constant circuit 44A includes a plurality of first time constant circuits (not shown) which attenuate the peak values of the electric current pulses (Iₒₚ₁(t) to Iₒₚ₄(t)) output from the synthesis section 43 over time. The RC time constants of each first constant circuit are different from each other. Specifically, the RC time constant of at least one second time constant circuit (not shown) of the plurality of first time constant circuits is a value in a range from 20 nsec or more to 50 nsec or less. Meanwhile, the RC time constant of one or a plurality of third time constant circuits (not shown) other than the second time constant circuit of the plurality of first time constant circuit is a value exceeding 50 nsec (typically, from 300 nsec or more to 1, 500 nsec or less). The correction circuit 44 is adapted to correct the peak value of the electric current pulse output from the synthesis section 43 through the use of the plurality of first time constant circuits such that the peak value is attenuated depending on the RC time constant of the RC time constant circuit over time. For example, as shown in FIG. 12B, the correction circuit 44 is adapted to output the electric current pulse (the electric current I_{A}(t)) with the peak value attenuated over time by the use of the first time constant circuit mentioned above.

For example, the RC time constant circuit 44A includes two first time constant circuits, an RC time constant T_{A1} of one first time constant circuit (the second time constant circuit) is a value in the range from 20 nsec or more to 50 nsec or less, and an RC time constant T_{A2} of the other first time constant circuit (the third time constant circuit) is a value exceeding 50 nsec (typically, 300 nsec or more and 1,500 nsec or less). At this time, the correction circuit 44 is adapted to output an assist electric current I_{A}(t) indicated in equation 10 as below.

$${I}_{A} ( t ) = ( \frac{{V}_{A}}{κ} ) \cdot g ( t ) \qquad [ Equation 10 ]$$

Herein, the symbol κ is a constant which converts an assist electric current factor V_{A} to the electric current value. The assist electric current factor V_{A} is expressed by equation 11 as below. Furthermore, the symbol g(t) in equation 11 is expressed by equation 12 as below. The symbol g(t) defines an attenuance which is attenuated over time via the peak value of the electric current pulse (the electric current Iₒₚ₋ₙₒₙₑ(t)) output from the synthesis section 43.

$$\begin{matrix}{V}_{A} = {V}_{offset} + {V}_{iop} - {V}_{ib} - {V}_{0} & [ Equation 11 ] \\ g ( t ) = v \cdot exp [ - \frac{t}{{T}_{A 1}} ] + ( 1 - v ) \cdot exp [ - \frac{t}{{T}_{A 2}} ] & [ Equation 12 ]\end{matrix}$$

The symbol ν is a weight of a term concerning the RC time constant T_{A1} and is a value greater than 0.5 since the RC time constant T_{A1} is dominant in the assist electric current I_{A}(t).

The assist electric current factor V_{A} in equation 10 includes a factor Vₒ which determines a device temperature T_{O} (an ambient temperature), a factor V_{ib} which determines a bias electric current, and a factor V_{iOP} which determines an operating electric current. That is, the correction circuit 44 is adapted to change the peak of the peak value of the electric current pulse output from the synthesis section 43 depending on the factor Vₒ which determines the device temperature T_{O} (the ambient temperature), the factor V_{ib} which determines the bias electric current, and the factor V_{iOP} which determines the operating electric current.

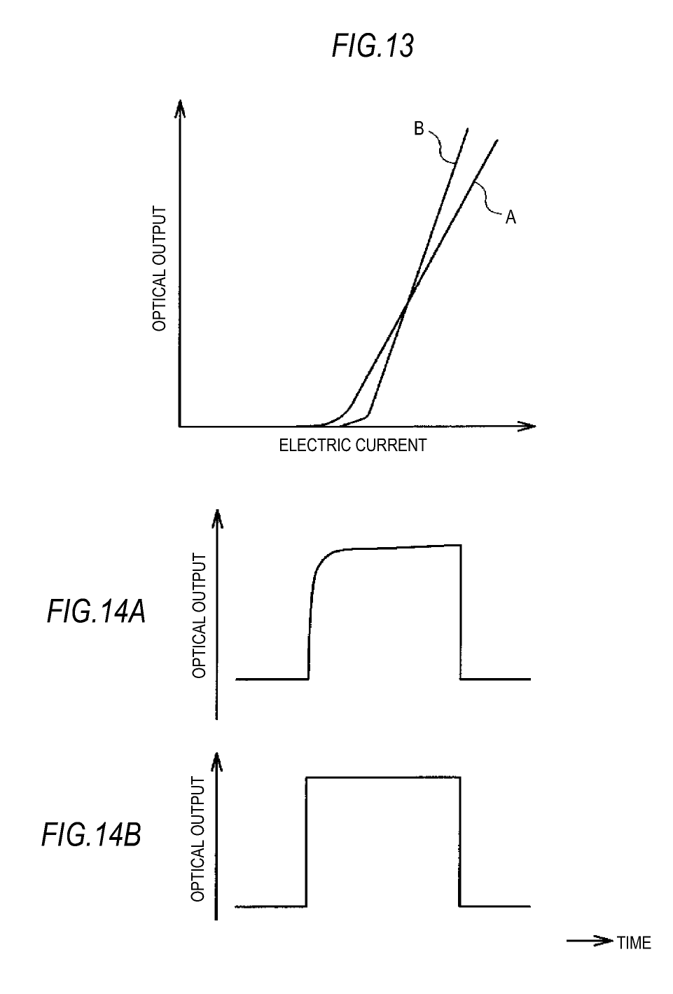

Furthermore, the assist electric current factor V_{A} in the equation 10 includes an offset electric voltage V_{offset}. As lines A and B shown in FIG. 13, the offset electric voltage V_{offset} for example, compensates the variations when a variation is generated in I-L characteristics and a variation is generated in the magnitude of the necessary assist electric current I_{A}(t) by the variation of the wavelength detuning Δλ which is the difference between the light emitting wavelength of the active layer and the oscillation wavelength of the laser device 10. Thus, the correction circuit 44 is able to change the peak of the peak value of the electric current pulse output from the synthesis section 43 depending on the magnitude of the wavelength detuning Δλ by adjusting the value of the offset voltage V_{offset}.

Furthermore, the equation 10 includes the symbol κ. Thus, the correction circuit 44 is also able to change the peak of the peak value of the electric current pulse output from the synthesis section 43 by adjusting the value of the constant κ converting the assist electric current factor V_{A} into the electric current value.

The RC time constant circuit 44A further includes a plurality of fourth time constant circuits (not shown) that adjust the peak of the peak value of the electric current pulse output from the synthesis section 43 when the synthesis section 43 continuously outputs the electric current pulse. The plurality of fourth time constant circuits is used so as to consider the heat factor remaining in the laser device 10 (in the active layer) when the synthesis section 43 outputs the electric current pulse to cause the laser device 10 to emit light. As a result, the correction circuit 44 is able to correct the peak value of the electric current pulse that is output from the synthesis section 43 so as to be varied in response to the temperature fluctuation of the active layer.

The RC time constants of the respective fourth time constant circuits are different from each other. Specifically, an RC time constant Tₜₕ₁ of at least one fifth time constant circuit (not shown) of the plurality of fourth time constant circuits is a value in the range from 20 nsec or more to 50 nsec or less. Meanwhile, an RC time constant circuit Tₜₕ₂ of one or a plurality of sixth time constant circuits (not shown) other than the fifth time constant circuit of the plurality of fourth time constant circuits is a value exceeding 50 nsec (typically, 300 nsec or more and 1,500 nsec or less).

For example, the RC time constant circuit 44A includes two fourth time constant circuits, the RC time constant Tₜₕ₁ of one first time constant circuit (the fifth time constant circuit) is a value in the range from 20 nsec or more to 50 nsec or less, and the RC time constant Tₜₕ₂ of the other fourth time constant circuit (the sixth time constant circuit) is a value exceeding 50 nsec (typically, 300 nsec or more and 1,500 nsec or less). At this time, the correction circuit 44 is adapted to output the assist electric current I_{A}(t) indicated in equation 13 as below.

I_{A}(t)=Iₘₐₓ(t)·g(t) [Equation 13]

The symbol Iₘₐₓ(t) in equation 13 is expressed by equation 14 as below. The symbol Iₘₐₓ(t) defined a maximum value of the assist electric current I_{A}(t). The symbol f(t) in equation 14 is expressed by equation 15 as below. The symbol f(t) indicates the fluctuation corresponding to the fluctuation of the heat factor remaining in the laser device 10 (in the active layer). Thus, the correction circuit 44 is able to perform the accurate correction as if the temperature fluctuation of the active layer is monitored in real time.

$$\begin{matrix} {I}_{max} ( t ) = ( \frac{{V}_{A}}{κ} ) \cdot ( 1 - f ( t ) ) & [ Equation 14 ] \\ On \text{-} time & [ Equation 15 ] \\ u \cdot [ 1 - exp ( - t / {T}_{th 1} ) ] + ( 1 - u ) \cdot [ 1 - exp ( - t / {T}_{th 2} ) ] = f ( t ) & \\ O ff \text{-} time & \\ u \cdot exp ( - t / {T}_{th 1} ) ] + ( 1 - u ) \cdot exp ( - t / {T}_{th 2} ) = f ( t ) & \end{matrix}$$

The symbol u is a weight of a term for the RC time constant Tₜₕ₁ and is a value greater than 0.5 since the RC time constant Tₜₕ₁ is dominant in the assist electric current I_{A}(t). The symbol t included in the left side of equation 15 indicates a starting time point of an on-period or a starting time point of an off-period when driving the laser device 10 in an on-off manner.

The synthesis section 45 is adapted to synthesize the electric current output from the synthesis section 43 and the correction electric current output from the correction circuit 44 and output the synthesized electric current to the outside (specifically, the laser device 10). For example, as shown in FIG. 11, the synthesis section 45 has a connection section which connects an output end of the synthesis section 43 with an output end of the correction circuit 44, and is able to add (superimpose) the electric current output from the synthesis section 43 and the correction electric current output from the correction circuit 44. For example, the synthesis section 45 is able to output four types of electric currents (Iₒᵤₜ₁(t) to Iₒᵤₜ₄(t)) in which the electric current (Iₒₚ₁(t) to Iₒₚ₄(t)) output from the synthesis section 43 is added to the correction electric currents (I_{A1}(t) to I_{A4}(t)) output from the correction circuit 44.

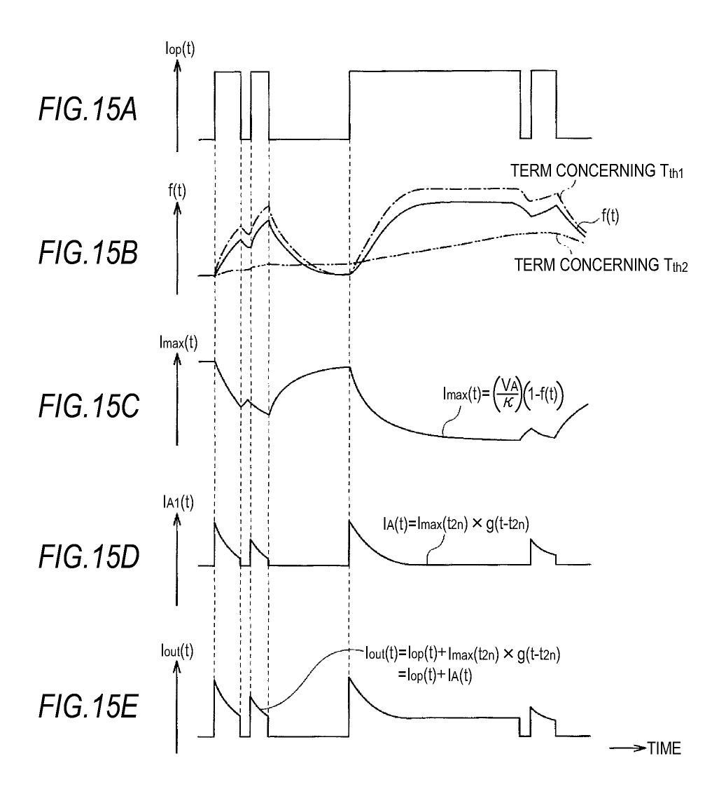

As a result, for example, when applying only the output of the synthesis section 43 to the laser device 10, as shown in FIG. 14A, in a case where the pulse waveform of the optical output of the laser device 10 is slowed compared to the waveform of the electric current pulse output from the synthesis section 43, by applying the electric current pulse in which the output of the synthesis section 43 and the output of the correction circuit 44 are superimposed on each other to the laser device 10, for example, as shown in FIG. 14B, it is possible to bring the pulse waveform of the optical output of the laser device 10 closer to a rectangular shape.

### [Operation]

In the light emitting apparatus 1 having such a configuration, for example, the rectangular electric current pulse (the electric current Iₒₚ(t)) is output from the synthesis section 43 (FIG. 15A). At this time, in the correction circuit 44, the symbol g(t) which regulates the attenuance attenuated via the peak value of the electric current pulse (the electric current Iₒₚ(t)) output from the synthesis section 43 over time, the symbol f(t) (FIG. 15B) which indicates the fluctuation corresponding to the fluctuation of the heat factor remaining in the laser device 10 (the active layer), and the symbol Iₘₐₓ(t), which regulates the maximum value of the assist electric current I_{A}(t), are derived through the use of the RC time constant circuit 44A. Next, in the correction circuit 44, a value of Iₘₐₓ(t₂ₙ) is held in the stating time point (t₂ₙ) of the on-period when driving the laser device 10 in the on-off manner, after the assist electric current I_{A}(t) attenuated according to g(t) setting the value as a starting point is derived (FIG. 15D), the assist electric current I_{A}(t) is output from the correction circuit 44. After that, an electric current pulse (Iₒᵤₜ(t)=Iₒₚ(t)+I_{A}(t)), in which the output of the synthesis section 43 and the output of the correction circuit 44 are superimposed on each other by the synthesis section 45, is applied to the laser device 10 (FIG. 15E). As a result, for example, the rectangular optical output as shown in FIG. 14B is emitted from the laser device 10 to the outside.

### [Principle]

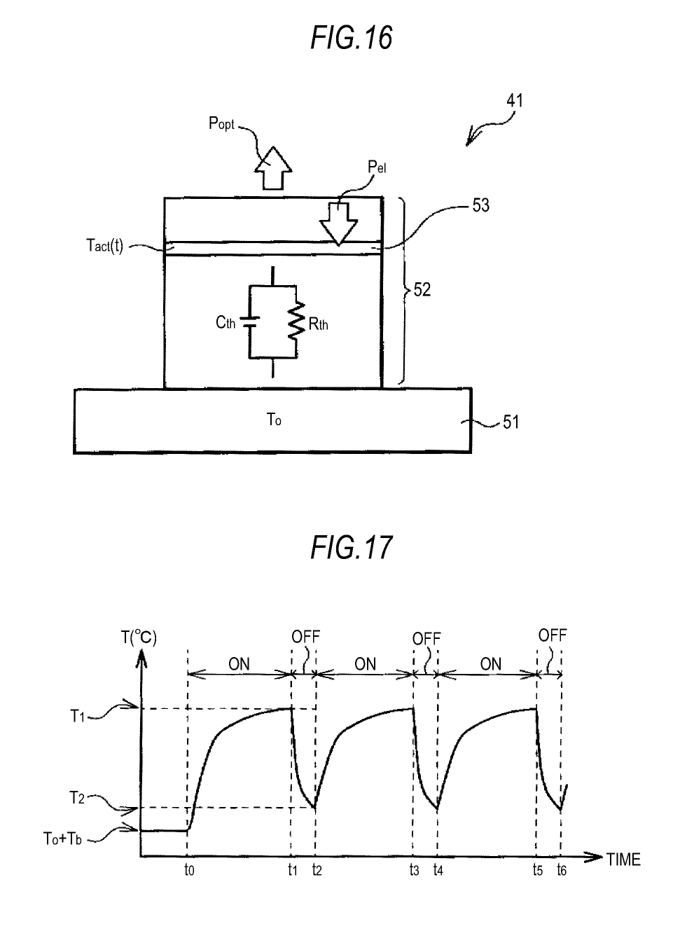

Next, a reason why the pulse waveform of the optical output of the laser device 10 comes closer to a rectangular shape will be described. FIG. 16 shows a thermal circuit of the laser device 10. If a temperature of a substrate 51 is Tₒ, a thermal capacity is Cₜₕ, a thermal resistance is Rₜₕ, a temperature (an active layer temperature) of the active layer 53 at a certain time t is T_{act}(t), a rise amount of the device temperature due to the bias electric current (<threshold value electric current) is Tₑ₁(t), injected energy is Pₑ₁, and the optical output is Pₒᵤₜ, the heat equation concerning the active layer temperature T_{act}(t) is expressed by equation 16 and equation 17 as below. In addition, the symbol RₜₕCₜₕ is a thermal time constant.

$$\begin{matrix}{T}_{act} ( t ) - {T}_{o} - ( {P}_{el} - {P}_{opt} ) {R}_{th} = - {R}_{th} {C}_{th} \frac{d}{d t} ( {T}_{act} ( t ) ) & [ Equation 16 ] \\ {T}_{act} ( t ) - {T}_{o} - {T}_{b} = - {R}_{th} {C}_{th} \frac{d}{d t} ( {T}_{act} ( t ) ) & [ Equation 17 ]\end{matrix}$$

Upon solving the equation 16 and the equation 17, the equation 16 and the equation 17 can be transformed into equation 18 and equation 19 as below.

$$\begin{matrix} {T}_{act} ( t ) = {T}_{o} + ( {P}_{el} - {P}_{opt} ) {R}_{th} \{ 1 - exp [ \frac{t - {t}_{2 n} + τ}{{R}_{th} {C}_{th}} ] \} & [ Equation 18 ] \\ {T}_{act} ( t ) = {T}_{o} + {T}_{b} + ( {T}_{2 n + 1} - {T}_{o} - {T}_{o} ) exp [ - \frac{t - {t}_{2 n + 1}}{{R}_{th} {C}_{th}} ] & [ Equation 19 ]\end{matrix}$$

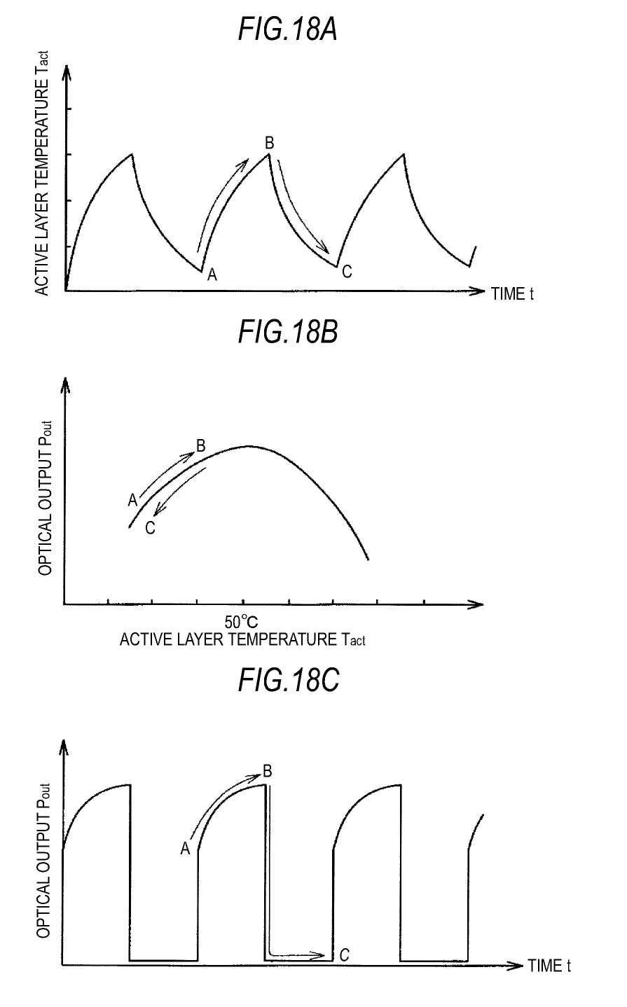

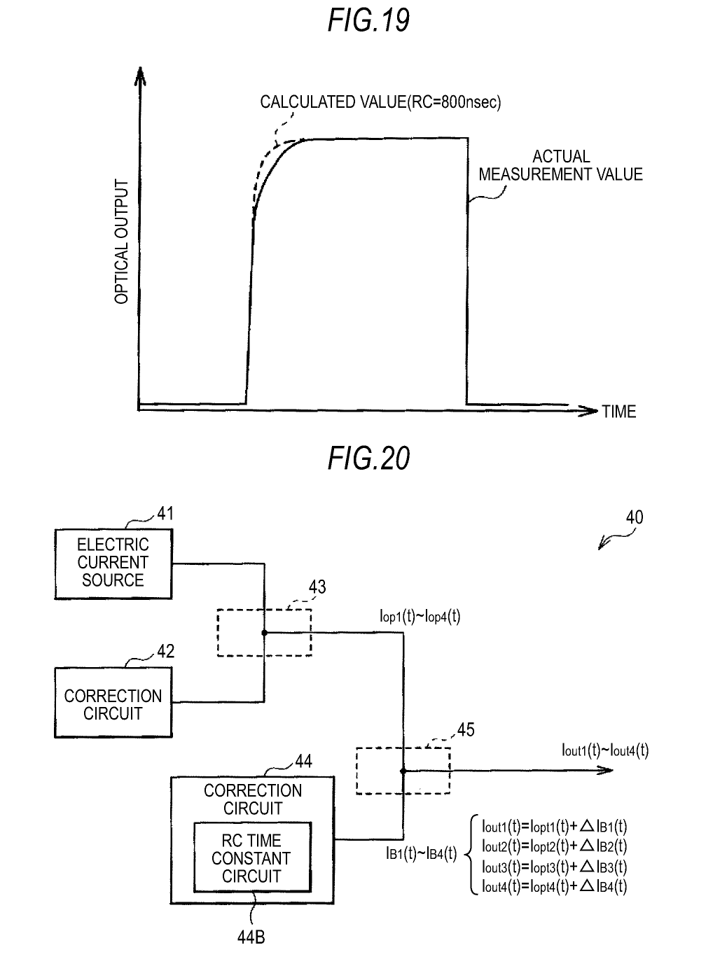

The symbol t₂ₙ (n is an integer equal to or greater than (0) of the equation 18 indicates the starting time point of the on-period when driving the laser device 10 in the on-off manner, as shown in FIG. 17. Meanwhile, the symbol t₂ₙ₊₁ of the equation 19 indicates the starting time point of the off-period when driving the laser device 10 in the on-off manner, as shown in FIG. 17. The symbol τ of the equation 18 is a coefficient that continuously maintains T_{act}(t) of the equation 18 and T_{act}(t) of the equation 19. In addition, when setting the value of the thermal time constant RₜₕCₜₕ to 1 μsec, upon indicating the equation 18 and the equation 19 on a graph, the result as shown in FIG. 18A is obtained.

However, generally, in the surface-emitting semiconductor laser, since the cavity length is very small 1λ to 2λ (λ is an oscillation wavelength), the oscillation wavelength is fixed by the cavity length. For that reason, the surface-emitting semiconductor laser is able to oscillate at the wavelengths different from the light emitting wavelength (a wavelength with a maximum gain) of the active layer. Thus, it is possible to arbitrarily select the device temperature with a minimum threshold value electric current depending on the design of the wavelength detuning Δλ. However, in practice, the device temperature with the minimum threshold value electric current is a value in the range of 0° C. to 60° C.

In a case where it is inclined to take a sufficient optical output at a high temperature side, it is necessary to greatly design the wavelength detuning Δλ. For example, in the surface-emitting semiconductor laser of 660 nm to 680 nm in which the active layer includes the red-based materials (GaInP or AlGaInP), if the wavelength detuning Δλ is about 19 nm, the device temperature Tₒ is about 50° C., and the threshold value electric current is the minimum. However, when the threshold value electric current has a temperature dependency, the optical output under constant electric current also has a temperature dependency. For example, as shown in FIG. 18B, in the case of the surface-emitting semiconductor laser in which the wavelength detuning Δλ is designed to 19 nm, when the device temperature Tₒ is about 50° C., the maximum optical output is obtained, and when the device temperature Tₒ is around 50° C., the optical output is reduced. As a result, the time change of the optical output can be drawn. As shown in FIGS. 18A to 18C, when transiting from A to B, the active layer temperature T_{act}(t) rises and the optical output Pₒᵤₜ also rises, and when transiting from B to C while the electric current is off, the active layer temperature T_{act}(t) is reduced, and the optical output Pₒᵤₜ at this timing becomes zero.

In this manner, it is possible to derive the time change of the optical output Pₒᵤₜ from the thermal equation and the active layer temperature dependency of the optical output Pₒᵤₜ. Thus, for example, as shown in FIGS. 18A to 18C, the result (the calculated value) was compared to the optical waveform (an actual measurement value) obtained by the actual measurement. Then, when setting the thermal time constant RₜₕCₜₕ to 800 nsec, it was found that both of them are consistent with each other after several 100 nsec after the pulse rise. However, at the pulse rise time, it was found that both of them are not consistent with each other. At the pulse rise time, it was found that the thermal time constant RₜₕCₜₕ is changed to a value smaller than 800 nsec by one order or more (generally, 20 nsec or more and 50 nsec or less).

It is considered that the existence of two time constants in the optical waveform is caused by a difference in heating state in the surface-emitting semiconductor laser after the pulse rise and pulse rise time. After the pulse rise, it is considered that the entire mesa in the surface-emitting semiconductor laser is heated, and for that reason, the time constant becomes greater. Meanwhile, at the pulse rise time, the active layer is locally heated, and it is considered that the time constant becomes smaller for that reason. Since the thermal equation is on the assumption that the entire mesa is heated, the optical waveform of the pulse rise time is not correctly expressed.

### [Effect]

Thus, in the present modified example, as mentioned above, the RC time constant circuit 44A in the correction circuit 44 is provided with a plurality of time constant circuits (a second time constant circuit and a third time constant circuit) having the different time constants. As a result, it is possible to correct the waveform of the electric current pulse output from the synthesis section 43 pulse-driving the laser device 10 through the use of the correction circuit 44 including the RC time constant circuit 44A such that the pulse waveform of the optical output of the laser device 10 becomes closer to a rectangular shape. In this manner, in the present modified example, through the use of the RC time constant circuit 44A, a portion of a gradual slope after the rise of the waveform of the electric current pulse output from the synthesis section 43 as well as a sharply curved portion at the rise can approach a rectangular shape. As a consequence, it is possible to reduce the waveform dullness of the optical output due to the wavelength detuning Δλ.

Furthermore, in the present modified example, in the correction circuit 44, the peak of the peak value of the electric current pulse output from the synthesis section 43 is changed depending on a factor Vₒ determining the device temperature Tₒ (the ambient temperature). As a result, the environmental temperature (for example, a temperature in a printer case) is changed, and thus, even when there is a change in the wavelength detuning Δλ, the waveform dullness of the optical output can be reduced.

Furthermore, in the present modified example, in the correction circuit 44, the peak value of the electric current pulse output from the synthesis section 43 fluctuates in response to the temperature fluctuation of the active layer. As a result, even in a case where the electric current pulse is continuously output from the synthesis section 43 and the thermal factor remains in the laser device 10 (in the active layer), it is possible to set the correction amount of the peak value of the electric current pulse to a suitable value. As a consequence, even when the synthesis section 43 continuously outputs the electric current pulse, the waveform dullness of the optical output can be reduced.

Furthermore, in the present modified example, in the correction circuit 44, it is possible to change the peak of the peak value of the electric current pulse output from the synthesis section 43 depending on the magnitude of the wavelength detuning Δλ, by adjusting the value of the offset voltage V_{offset} or by adjusting the value of the constant κ converting the assist electric current factor V_{A} into the electric current value. It is preferable to determine which value is adjusted from a tendency of the fluctuation of the optical output with respect to the temperature change. For example, the electric current stenosis diameter of the laser device 10 becomes greater than a desired value by the manufacturing irregularity. In this case, it is preferable to adjust the value of the constant κ by an increase in fluctuation amount of the optical output to the temperature change (that is, the temperature dependency of the optical output becomes higher). Furthermore, for example, the wavelength detuning Δλ of the laser device 10 is increased by the manufacturing irregularity. In this case, it is preferable to adjust the value of the offset voltage V_{offset} by the shift of the temperature with maximum optical output to the high temperature side (that is, the temperature dependency of the optical output is shifted to the high temperature side). In this manner, in the present modified example, since a preferable correcting method can be selected based on the tendency of the fluctuation of the optical output with respect to the temperature change, the waveform dullness of the optical output can reliably be reduced.

### Second Modified Example

FIG. 20 shows an example of a schematic configuration of the laser driving section 40 used in the light emitting apparatus 2 according to the present modified example. The laser driving section 40 according to the present modified example has the electric current source 41, the correction circuit 42, the synthesis section 43, the correction circuit 44, and the synthesis section 45. The correction circuit 44 has an RC time constant circuit 44B instead of the RC time constant circuit 44A in the first modified example. In the present modified example, the correction circuit 44 corrects the droop.

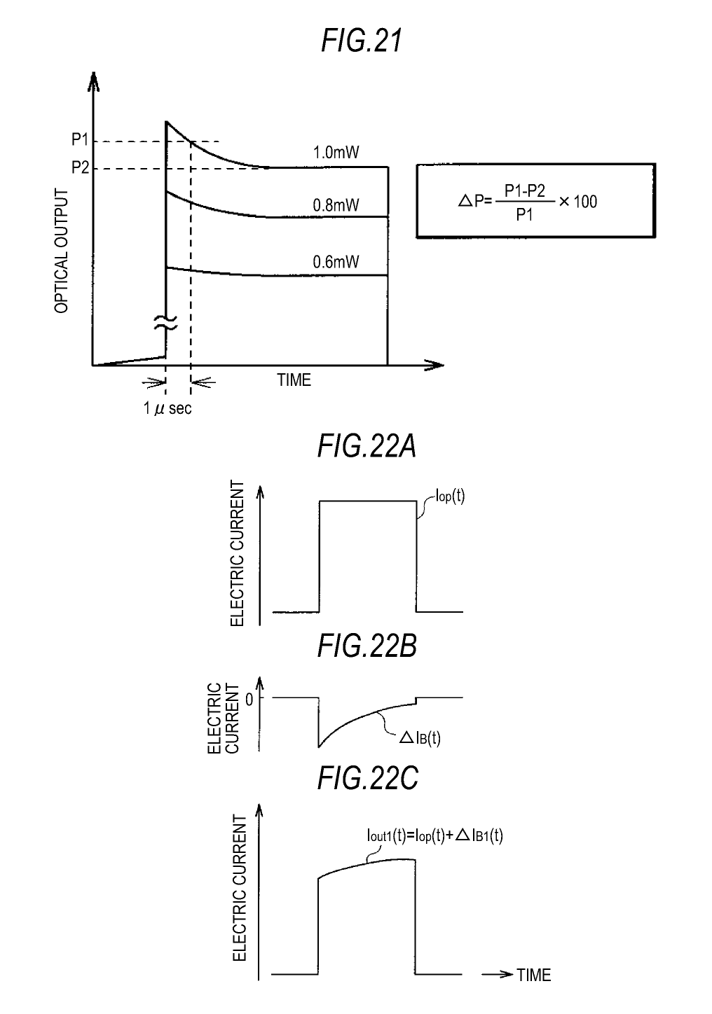

Herein, the droop will be described. For example, in the surface-emitting semiconductor laser having the oscillation wavelength of 680 nm, when increasing the ambient temperature by 10° C. from the driving state of 50° C. and 1 mW, the optical output drops by about 20%. Even in a case of pulse-operating the surface-emitting semiconductor laser, the temperature of the device gradually rises simultaneously with the injection of the electric current pulse to the device, and the optical output also gradually drops due to the temperature rise. This is a phenomenon called a “droop” and is well understood in semiconductor lasers. The higher the injection electric power is, the greater the phenomenon occurs. For example, as shown in FIG. 21, it is noted that, as the injection electric power is shifted from 0.6 mW to 1 mW, the decline amount of the optical output is increased. In the case of quantitatively evaluating the droop, for example, the equation as below is used.

ΔP=(P1−P2)/P×100(%)

The symbol ΔP in the equation is a droop (an optical output decline) amount. The symbol P1 is an optical output when elapsing from the rise by 1 μsec, and the symbol P2 is an optical output when the optical output enters a steady state.

The correction circuit 44 corrects the waveform of the electric current pulse output from the synthesis section 43 such that the pulse waveform of the optical output of the semiconductor laser becomes closer to a rectangular shape through the use of the RC time constant circuit 44B. For example, as shown in FIG. 22C, the correction circuit 44 corrects the waveforms of the electric current pulses (Iₒₚ₁(1) to Iₒₚ₄(t)) such that the peak value thereof is changed (saturated) depending on the RC time constant of the RC time constant circuit 44B. In addition, Iₒₚ(t) is used as a general term of Iₒₚ₁(1) to Iₒₚ₄(t).

For example, as shown in FIG. 22B, the correction circuit 44 outputs the electric current pulse (ΔI_{B}(t)) which has a peak value of a sign (negative) opposite to a sign of a peak value of the electric current pulse (Iₒₚ(t)). For example, as shown in FIG. 22B, the electric current pulse (ΔI_{B}(t)) is a pulse waveform which is changed (saturated) over time depending on the RC time constant of the RC time constant circuit 44B. That is, the absolute value of the peak value of the electric current pulse (ΔI_{B}(t)) is firstly large, gradually decreases, and finally becomes zero or a value close to zero.

The RC time constant circuit 44B includes a seventh time constant circuit (not shown) which changes the peak value of the electric current pulse (Iₒₚ(t)) over time. The RC time constant of the seventh time constant circuit is a value in the range from 1 μsec or more to 3 μsec or less. The correction circuit 44 is adapted to correct the peak value of the electric current pulse (ΔI_{B}(t)) through the use of the seventh time constant circuit such that the peak value of the electric current pulse (Iₒₚ(t)) is changed (saturated) over time depending on the RC time constant of the seventh time constant circuit. For example, as shown in FIG. 22B, the correction circuit 44 is adapted to output the electric current pulse (ΔI_{B}(t)), in which the peak value is changed (saturated) over time, through the use of the seventh time constant circuit mentioned above. Specifically, the correction circuit 44 is adapted to output the electric current pulse (ΔI_{B}(t)) shown in equation 20 as below.

I_{B}(t)=ΔIₘₐₓ_{_{—}}_{B}(t)·exp(−t/Tₜₕ₁) [Equation 20]

Herein, the symbol ΔI_{max B} is a correction electric current at the pulse input time (t=0). The symbol Tₜₕ₁ is a time constant which indicates a time change until the correction electric current reaches zero, and corresponds to the RC time constant of the seventh time constant circuit.

As described below, the greater the driving electric current is, the greater the absolute value of ΔI_{max B}(t) corresponding to an initial value of the correction electric current is. For that reason, ΔI_{max B}(t) has an item proportional to the driving electric current Iₒₚ(t) (before the correction). Furthermore, as described below, the higher the ambient temperature of the semiconductor laser is, the greater the absolute value of ΔI_{max B}(t). For that reason, ΔI_{max B}(t) has a term proportional to the ambient temperature Tₐ of the semiconductor laser. Thus, ΔI_{max B}(t) is expressed by equation 21 as below.

ΔIₘₐₓ_{_{—}}_{B}(t)=−A·{Iₒₚ−B(Tₓ−Tₐ)} [Equation 21]

Herein, symbols A and B are positive constants that indicate the dependencies of the operation electric current Iₒₚ(t) and the ambient temperature Tₐ, respectively, and the optimal values thereof are different from the devices. For example, in the case of the device having excellent linearity of the I-L characteristics, A of a small value is sufficient. Furthermore, for example, in a case where the temperature dependency of the threshold value is great in the I-L characteristics, B of a large value is preferable. Tₓ is also the constant, and the optimal value thereof differs depending on the wavelength detuning Δλ. When the wavelength detuning Δλ is great, since the droop amount is small when the temperature of the device is high compared to the case of the low wavelength detuning Δλ, it is preferable that the value of the Tₓ is great. Speaking about the behavior of the wavelength detuning Δλ and the optical output due to the temperature change, there is little variation between the devices. Thus, Tx and B are constants scarcely necessary for adjusting for each device, and is preferably a fixed value common to each device. Meanwhile, the linearities of the I-L characteristics are slightly different from each other for each production and for each device. Thus, it is preferable that A be a value adjusted for each device.

The RC time constant circuit 44B further includes an eighth time constant circuit (not shown) that adjusts the peak of the peak value of the electric current pulse output from the electric current source 41, when the electric current source 41 continuously outputs the electric current pulse. The eighth time constant circuit is used so as to consider the thermal factor remaining in the semiconductor laser (the active layer) including the vertical resonator structure with the active layer interposed between a pair of multi-layer film reflecting mirrors when the electric current source 21 outputs the electric current pulse to cause the semiconductor laser to emit light. The RC time constant of the eighth time constant circuit is about a value of heat time constant of the semiconductor laser, and is, specifically, a value in the range from 1 μsec or more to 3 μsec or less. As a result, the correction circuit 22 is able to correct the peak value of the electric current pulse output from the electric current source 21 so as to be fluctuated in response to the temperature fluctuation of the semiconductor laser (the active layer), by the use of the eighth time constant circuit.

Herein, when the temperature fluctuation of the semiconductor laser (the active layer) is F(t), and the heat time constant (the constant of the eighth time constant circuit) of the semiconductor laser is Tₜₕ₂, the F(t) is expressed as indicated in equation 22 as below. The symbol t in the equation indicates a time elapse from each on or each off.

$$F ( t ) = \{ \begin{matrix}1 - exp ( - t / {T}_{th 2} ) & … on time \\ exp ( - t / {T}_{th 2} ) & … off time\end{matrix} \qquad [ Equation 22 ]$$

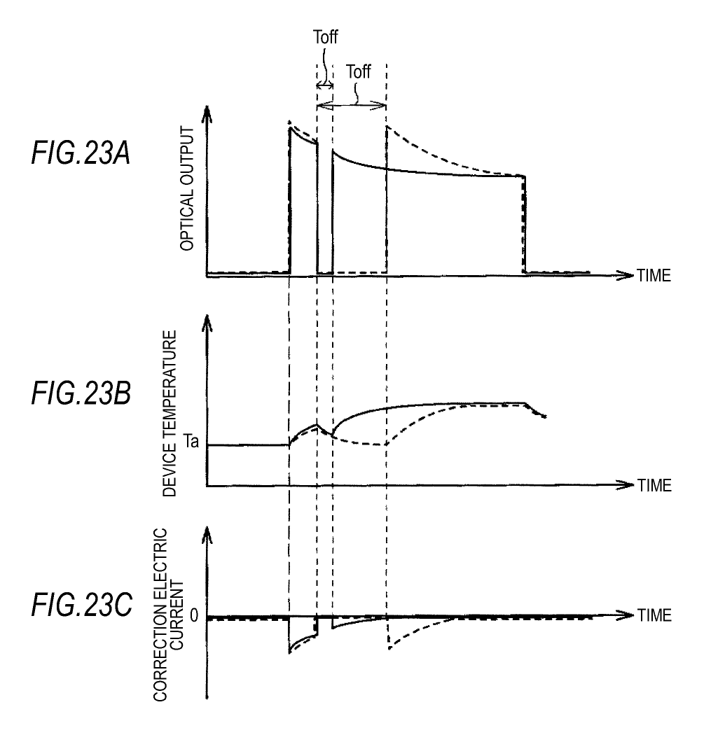

FIGS. 23A to 23C show an example of a relationship between the optical output, the device temperature, and the correction electric current. As shown in FIGS. 23A to 23C, when a first pulse is input, the device temperature of the semiconductor laser rises by the self heating. Next, a second pulse is input. Herein, as an off period T_{off}, until the second pulse is input from the first pulse, is long, heat generated by the self heating is discharged to the outside. Thus, the device temperature of the semiconductor laser becomes closer to the ambient temperature Tₐ. Thus, the correction electric current to be applied is increased (in a negative direction) in response to the length of the off period T_{off}. Thus, the correction electric current ΔI_{max B}(t) to a certain pulse pattern is expressed as indicated in equation 23 as below.

ΔIₘₐₓ_{_{—}}_{B}(t)=−A·{Iₒₚ−B·(Tₓ−Tₐ)}·{1−F(t)} [Equation 23]

However, when the ambient temperature Tₐ is low and the driving electric current Iₒₚ is low, there is a possibility that a right side of the equation receives a positive value. This suggests that there is a possibility of the correction electric current ΔI_{max B}(t) being given in a positive direction in such a condition. However, in such a condition, since the generated self heating is small, the droop is hardly generated. Thus, when it is not necessary to give the correction electric current ΔI_{max B}(t) in the positive direction, and the right side of the equation is positive, as indicated in equation 24, the correction electric current ΔI_{max B}(t) is set to zero.

ΔIₘₐₓ_{_{—}}_{B}(t)=0 . . . −A·{Iₒₚ−B·(Tₓ−Tₐ)}·{1−F(t)}>0 [Equation 24]

For example, as shown in FIG. 20, in the laser driving section 40, the output terminals of the synthesis section 43 and the correction circuit 44 are connected to each other in the synthesis section 45. Thus, the laser driving section 40 is adapted to output the electric current pulse (Iₒᵤₜ(t)=Iₒₚ(t)+I_{B}(t)) in which the output of the synthesis section 43 is superimposed with the output of the correction circuit 44. As a result, for example, when applying only the output of the synthesis section 43 to the semiconductor laser, in a case where the pulse waveform of the optical output of the semiconductor laser is slowed as shown in FIG. 14A, by applying the electric current pulse, in which the output of the synthesis section 43 and the output of the correction circuit 44 are superimposed on each other, to the semiconductor laser, it is possible to bring the pulse waveform of the optical output of the semiconductor laser closer to a rectangular shape.

### [Operation]

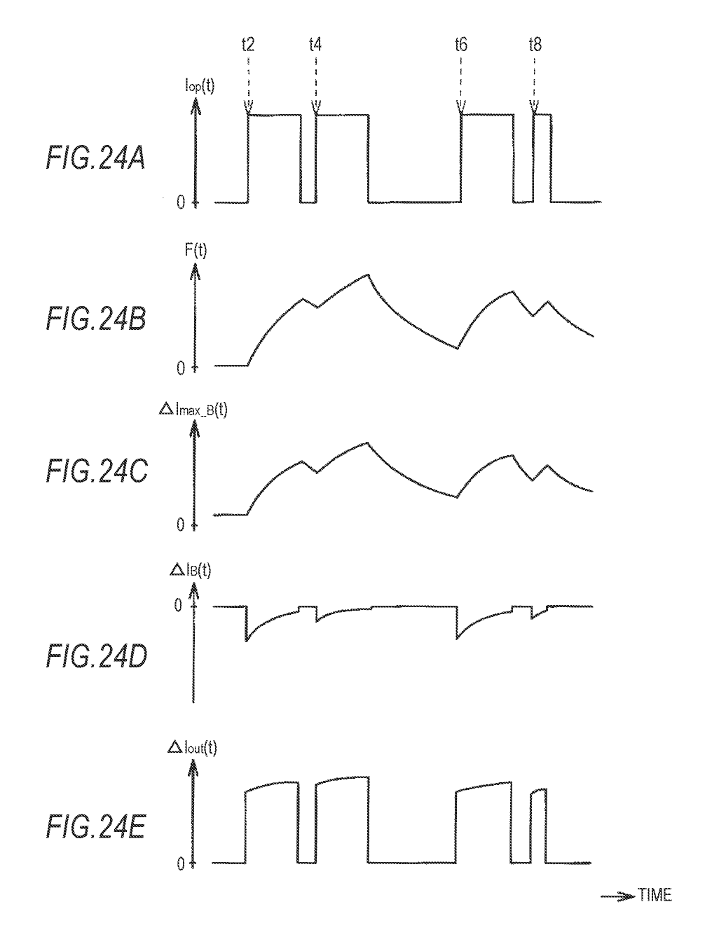

In the light emitting apparatus 2 of such a configuration, the electric current pulse (the electric current Iₒₚ(t)) is output from the synthesis section 43 (FIG. 24A). At this time, in the correction circuit 44, F(t) (FIG. 24B) indicating the fluctuation corresponding to the fluctuation of the thermal factor remaining in the semiconductor layer (in the active layer), and ΔI_{max B}(t) (FIG. 24C) regulating the initial value of the correction electric current are derived, through the use of the RC time constant circuit 44B. Next, in the correction circuit 44, the value of ΔI_{max B}(t) is held at the starting time point (t₂ₙ) of the on period when driving the semiconductor laser in the on-off manner, and after the electric current pulse (ΔI_{B}(t)) attenuated according to exp (−t/Tₜₕ₁) using the value as the starting point is derived (FIG. 24D), the electric current pulse (ΔI_{B}(t)) is output from the correction circuit 44. After that, the electric current pulse (Iₒᵤₜ(t)=Iₒₚ(t)+ΔI_{B}(t)), in which the output of the synthesis section 43 is superimposed with the output of the correction circuit 44, is applied to the semiconductor laser array 1 by the laser driving section 40 (FIG. 24E). As a result, the rectangular optical output is ejected from the semiconductor laser array 1 to the outside.

### [Effect]

Next, an effect of the light emitting apparatus 2 according to the modified example will be described.

Generally, in the surface-emitting semiconductor laser, since the resonator structure is minute, the temperature rise of the active layer due to the electric current injection is great, and the optical output drops due to the temperature rise. For example, in the surface-emitting semiconductor laser having the oscillation wavelength of 680 nm, when increasing the ambient temperature by 10° C. from the driving state of 50° C. and 1 mW, the optical output declines by about 20%. Even in a case of pulse-operating the surface-emitting semiconductor laser, the temperature of the device gradually rises simultaneously with the injection of the electric current pulse to the device, and the optical output also gradually declines along with the temperature rise.

As a method of correcting the phenomenon called a droop, for example, there is a method described in JP-A-2002-254697. However, in the method described in JP-A-2002-254697, in a case where the droop curve is changed depending on a difference in driving condition such as the light emitting pattern, the electric current value, and the temperature, there is a problem in that it is not easy to accurately correct the droop.

Meanwhile, in the present modified example, the correction circuit 44 includes the seventh time constant circuit (the circuit including the time constant Tₜₕ₁) giving the time change of the correction electric current, and the eighth time constant circuit (the circuit including the time constant Tₜₕ₂) giving the maximum electric current ΔI_{max B}(t) of each pulse starting time corresponding to the initial value of the correction electric current. Herein, the correction electric current ΔI_{max B}(t) is adapted to be changed in response to the ambient temperature Tₐ of the semiconductor laser, the driving electric current Iₒₚ(t), and the temperature fluctuation F(t) of the semiconductor laser (the active layer). In addition, the temperature fluctuation F(t) of the semiconductor laser (the active layer) is adapted to be changed in response to the time constant Tₜₕ₂. As a result, even in a case where the droop curve is changed depending on the difference of the driving condition such as the light emitting pattern, the electric current value, and the temperature, the droop can accurately be corrected.

### Third Modified Example

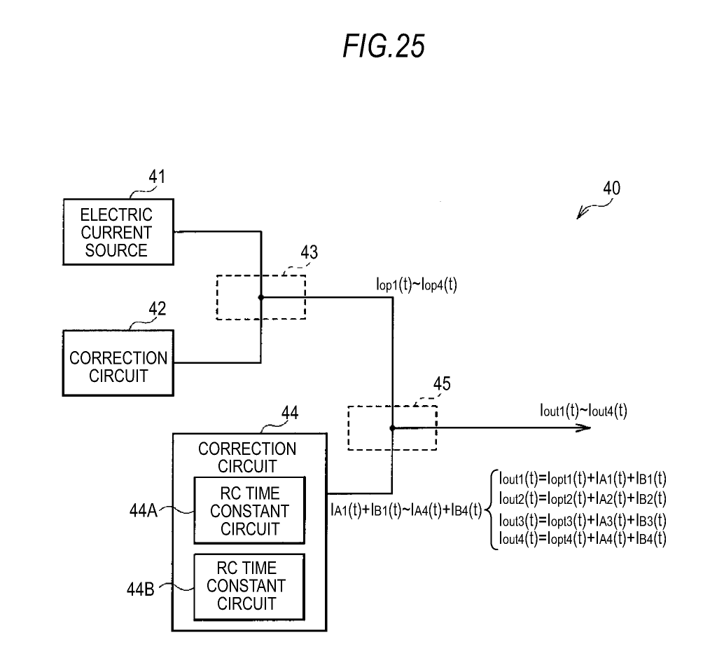

FIG. 25 shows an example of a schematic configuration of the laser driving section 40 which is used in the light emitting apparatus 2 according to the present modified example. The laser driving section 40 according to the present modified example has the electric current source 41, the correction circuit 42, the synthesis section 43, the correction circuit 44, and the synthesis section 45. The correction circuit 44 has the RC time constant circuits 44A and 44B. In the present modified example, the correction circuit 44 is adapted to reduce the waveform dullness of the optical output due to the waveform detuning Δλ through the use of the RC time constant circuit 44A and correct the droop through the use of the RC time constant circuit 44B.

For example, as shown in FIG. 25, in the laser driving section 40, the output terminals of the synthesis section 43 and the correction circuit 44 are connected to each other in the synthesis section 45. Thus, the laser driving section 40 is adapted to output the electric current pulse (Iₒᵤₜ(t)=Iₒₚ(t)+I_{A}(t)+I_{B}(t)) in which the output of the synthesis section 43 is superimposed with the output of the correction circuit 44. As a result, it is possible to bring the pulse waveform of the optical output of the semiconductor laser closer to a rectangular shape.

### [Operation]

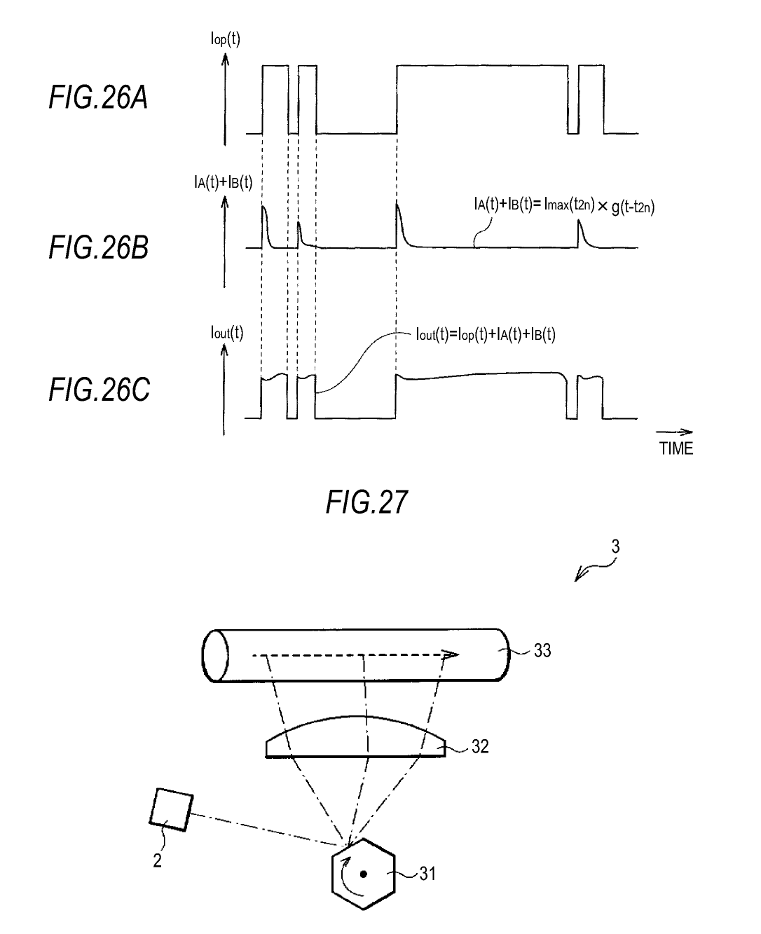

In the light emitting apparatus 2 having such a configuration, the rectangular electric current pulse (the electric current Iₒₚ(t)) is output from the synthesis section 43 (FIG. 26A). At this time, in the correction circuit 44, the assist electric current I_{A}(t) and the correction electric current ΔI_{B}(t) are generated through the use of the RC time constant circuit 44A to output I_{A}(t)+ΔI_{B}(t). After that, by the synthesis section 45, the electric current pulse (Iₒᵤₜ(t)=Iₒₚ(t)+I_{A}(t)+I_{B}(t)), in which the output of the synthesis section 43 is superimposed with the output of the correction circuit 44, is applied to the laser device 10 (FIG. 26C). As a result, the rectangular optical output, for example, as shown in FIG. 14B is ejected from the laser device 10 to the outside.

### [Effect]

Next, an effect of the light emitting apparatus 2 according to the present modified example will be described. In the present modified example, as mentioned above, the RC time constant circuits 44A and 44B are provided in the correction circuit 44. As a result, it is possible to correct the waveform of the electric current pulse output from the synthesis section 43 performing the pulse-driving of the laser device 10 so that the pulse waveform of the optical output of the laser device 10 becomes closer to a rectangular shape, through the use of the RC time constant circuits 44A and 44B. As a consequence, it is possible to reduce the waveform dullness of the optical output due to the wavelength detuning Δλ and to accurately correct the droop.

### Application Example

The light emitting apparatus 2 according to the embodiments or the modified example thereof can be suitably applied to, for example, a printing apparatus such as a laser printer, and an optical communication device such as a multi-channel integrated optical device.

For example, it is possible to apply a light emitting apparatus 2 as the light source of the printing apparatus. For example, as shown in FIG. 27, a printing apparatus 3 includes the light emitting apparatus 2, a polygon mirror 31 which reflects light from the light emitting apparatus 2 and scans the reflected light, a fθ lens 32 which guides light from the polygon mirror 31 to a photosensitive drum 33, the photosensitive drum 33 which receives light from the fθ lens 32 to form an electrostatic latent image, and a toner supplier (not shown) which attaches the toner depending on the electrostatic latent image to the photosensitive drum 33.

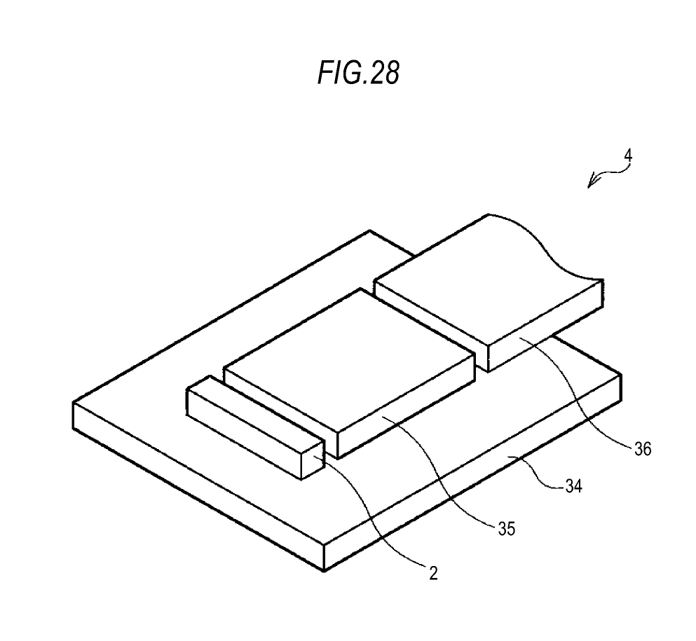

Furthermore, for example, it is also possible to apply the light emitting apparatus 2 as the light source of the optical communication device. For example, as shown in FIG. 28, an optical communication device 4 includes a support substrate 34 which supports the light emitting apparatus 2, an optical waveguide 35 in which an optical input end thereof is placed corresponding to an optical output end of the light emitting apparatus 2, and an optical fiber 36 in which an optical input end thereof is provided corresponding to the optical output end of the optical waveguide 35.

The present disclosure contains subject matter related to that disclosed in Japanese Priority Patent Application JP 2011-075468 filed in the Japan Patent Office on Mar. 30, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A correction circuit comprising:
a temperature rise derivation section which derives a temperature rise amount of a first channel of a multi-channel surface-emitting laser array due to the heating by at least one or a plurality of second channels adjacent to the first channel out of all channels included in the laser array; and
a first correction section which corrects a waveform of an electric current pulse which is output from an electric current source capable of independently driving the laser array for each channel, to the first channel, based on the temperature rise amount derived by the temperature rise derivation section.

2. The correction circuit according to claim 1,
wherein the temperature rise derivation section has a first RC time constant circuit having a thermal resistance R and a thermal capacity C of magnitudes depending on a distance between the first channel and the second channel for each second channel, and derives the temperature rise amount based on the thermal resistance R, the thermal capacity C, and a heat flow W corresponding to a magnitude of electric current flowing in the second channel.

3. The correction circuit according to claim 2,
wherein the first correction section corrects the temperature rise amount, based on an ambient temperature, and an electric current amount which is output to the first channel.

4. The correction circuit according to claim 3,
wherein the laser array has a temperature detection device which detects the ambient temperature, and the first correction section corrects the temperature rise amount based on the ambient temperature obtained from the temperature detection device and the electric current amount output to the first channel.

5. The correction circuit according to claim 1, further comprising:
a second correction section which corrects the waveform of the electric current pulse after being corrected by the first correction section such that the pulse waveform of the optical output of the first channel becomes closer to a rectangular shape.

6. The correction circuit according to claim 5,
wherein the second correction section includes a plurality of first time constant circuits which attenuate a peak value of the electric current pulse over time, the RC time constants of the respective first time constant circuits are different from each other, an RC time constant of at least one second time constant circuit of the plurality of first time constant circuits has a value in a range from 20 nsec or more to 50 nsec or less, and an RC time constant of one or a plurality of third time constant circuits other than the second time constant circuit of the plurality of first time constant circuits has a value exceeding 50 nsec.

7. The correction circuit according to claim 6,
wherein the respective channels have a vertical resonator structure with an active layer interposed between a pair of multilayer film reflecting mirrors, and the second correction section corrects the waveform of the electric current pulse such that the peak value of the electric current pulse fluctuates in response to the temperature fluctuation of the active layer.

8. The correction circuit according to claim 7,
wherein the second correction section includes a plurality of fourth time constant circuits which adjust the peak of the peak value of the electric current pulse, the RC time constants of the respective fourth time constant circuits are different from each other, an RC time constant of at least one fifth time constant circuit of the plurality of fourth time constant circuits has a value in a range from 20 nsec or more to 50 nsec or less, and an RC time constant of one or a plurality of sixth time constant circuits other than the fifth time constant circuit of the plurality of fourth time constant circuits has a value exceeding 50 nsec.

9. The correction circuit according to claim 5,
wherein the second correction section includes a seventh time constant circuit giving the time change of the correction electric current, and an eighth time constant circuit giving a maximum electric current amount of each pulse starting time corresponding to an initial value of the correction electric current, and the second correction section corrects the waveform of the electric current pulse after being corrected by the first correction section such that the peak value of the electric current pulse is saturated over time in response to the RC time constants of the seventh time constant circuit and the eighth time constant circuit.

10. The correction circuit according to claim 9,
wherein the RC time constants of the seventh time constant circuit and the eighth time constant circuit have values in the range from 1 μsec or more to 3 μsec or less.

11. The correction circuit according to claim 10,
wherein the respective channels have a vertical resonator structure with the active layer interposed between a pair of multilayer film reflecting mirrors, and the second correction section corrects the waveform of the electric current pulse such that the peak value of the electric current pulse fluctuates in response to a temperature fluctuation of the active layer.

12. The correction circuit according to claim 9,
wherein the second corrections section changes the maximum electric current amount in response to the ambient temperature, the electric current amount after being corrected by the first correction section, and the temperature fluctuation of the active layer.

13. A driving circuit comprising:
an electric current source which is able to independently drive a multi-channel surface-emitting laser array for each channel; and
a correction circuit which corrects a waveform of an electric current pulse output from the electric current source,
wherein the correction circuit has
a temperature rise derivation section which derives a temperature rise amount of a first channel of the laser array due to the heating by at least one or a plurality of second channels adjacent to the first channel out of all channels included in the laser array, and
a correction section which corrects the waveform of the electric current pulse which is output from an electric current source, capable of independently driving the laser array for each channel, to the first channel, based on the temperature rise amount derived by the temperature rise derivation section.

14. A light emitting apparatus comprising:
a multi-channel surface-emitting laser array; and
a driving circuit which drives the laser array,
wherein the driving circuit has
an electric current source which is able to independently drive the multi-channel surface-emitting laser array for each channel, and
a correction circuit which corrects a waveform of an electric current pulse output from the electric current source, and
the correction circuit has
a temperature rise derivation section which derives a temperature rise amount of a first channel of the laser array due the to heating by at least one or a plurality of second channels adjacent to the first channel out of all channels included in the laser array, and
a correction section which corrects the waveform of the electric current pulse which is output from an electric current source, capable of independently driving the laser array for each channel, to the first channel, based on the temperature rise amount derived by the temperature rise derivation section.

15. A method of correcting an electric current pulse waveform comprising:
deriving a temperature rise amount of a first channel of a multi-channel surface-emitting laser array due to the heating by at least one or a plurality of second channels adjacent to the first channel out of all channels included in the laser array; and
correcting a waveform of an electric current pulse output from an electric current source, which is able to independently drive the laser array for each channel, to the first channel, based on the temperature rise amount derived in the temperature rise derivation.
